(19) United States
(12) Patent Application Publication
(10) Pub. No.: US 2015/0312279 A1
(43) Pub. Date: Oct. 29, 2015

(54) REMOTE STATION PROTECTION

(71) Applicant: QUALCOMM Incorporated, San Diego, CA (US)

(72) Inventors: Maarten Menzo Wentink, Naarden (NL); Albert van Zeist, Woerden (NL)

(21) Appl. No.: 14/688,235

(22) Filed: Apr. 16, 2015

Related U.S. Application Data
(60) Provisional application No. 61/986,079, filed on Apr. 29, 2014.
(60) Provisional application No. 62/024,905, filed on Jul. 15, 2014.
(60) Provisional application No. 62/026,460, filed on Jul. 18, 2014.

(51) Int. Cl. H04L 29/06; H04L 5/00

(52) U.S. Cl. CPC H04L 63/20; H04L 5/0007; H04W 84/12

(57) ABSTRACT

Methods, systems, and devices are described for selectively enabling legacy protection in a WLAN. A method may include receiving, by an access point, a DSSS signal from a station, and activating legacy protection within a WLAN of the access point based at least in part on the received DSSS signal. For instance when a station cannot be initially detected, the access point may transmit an OFDM signal indicating a NAV period associated with a remote station initial access period. The access point may then receive a DSSS transmission from a remote station during the remote station initial access period. A method may include receiving, at a wireless station, an indication of a NAV period associated with remote station initial access, monitoring for radio transmissions during the NAV period, and transmitting a DSSS signal during the NAV period based on the monitoring.

### CROSS REFERENCES

The present application for patent claims priority to U.S. Provisional Patent Application No. 61/986,079 by Wentink et al., entitled “Remote Station Protection,” filed Apr. 29, 2014; U.S. Provisional Patent Application No. 62/024,905 by Wentink et al., entitled “Remote Station Protection,” filed Jul. 15, 2014; and U.S. Provisional Patent Application No. 62/026,460 by Wentink et al., entitled “Remote Station Protection,” filed Jul. 18, 2014 assigned to the assignee hereof, and expressly incorporated by reference herein.

### BACKGROUND

1. Field of the Disclosure

The following relates generally to wireless communication, and more specifically to activating legacy protection based on receiving a Direct Sequence Spread Spectrum (DSSS) signal from a wireless station (STA).

2. Description of Related Art

Wireless communications systems are widely deployed to provide various types of communication content such as voice, video, packet data, messaging, broadcast, and so on. These systems may be multiple-access systems capable of supporting communication with multiple users by sharing the available system resources (e.g., time, frequency, and power). Wireless Local Area Networks (WLANs), such as Wi-Fi (IEEE 802.11) networks are widely deployed and used. Other examples of such multiple-access systems may include code-division multiple access (CDMA) systems, time-division multiple access (TDMA) systems, frequency-division multiple access (FDMA) systems, and orthogonal frequency-division multiple access (OFDMA) systems.

Generally, a wireless multiple-access communications system may include a number of base stations or access points (APs), each simultaneously supporting communication for multiple mobile devices or STAs, for example, in a particular WLAN. APs may communicate with STAs on downstream and upstream links. Each AP has a coverage range, which may be referred to as the coverage area of the cell. When a STA is close to an AP, for example, the STA and the AP may communicate using Orthogonal Frequency Division Multiplexing (OFDM), as OFDM provides high data rates and is well suited for short range communications. However, when a STA moves farther away from the AP, the two devices may communicate more effectively using Direct Sequence Spread Spectrum (DSSS).

Decreases in communication performance, e.g., throughput and connectivity, can occur when a STA that is out of Clear Channel Assessment (CCA) range of OFDM communications attempts to communicate with an AP using DSSS, particularly when OFDM traffic in the WLAN is heavy. In this scenario, the DSSS STA may experience trouble in accessing the WLAN served by the AP. When OFDM traffic in the WLAN is minimal, the STA may not experience any problems accessing the WLAN. In both situations, the DSSS STA perceives the network as free. This can present problems for the STA utilizing DSSS in accessing the network and in maintaining reliable communication performance with the AP.

### SUMMARY

The described features generally relate to one or more improved systems, methods, or apparatuses for activating legacy protection based on receiving a Direct Sequence Spread Spectrum (DSSS) signal from a station (STA). An access point (AP) may receive a first DSSS signal from a station, and based at least in part on the received first DSSS signal, activate legacy protection in a wireless local area network (WLAN). The AP may compare a received signal strength of the first DSSS signal to a threshold and activate legacy protection based on the comparison, e.g., if the received signal strength is less than a threshold, indicating that the STA is beyond Orthogonal Frequency Division Multiplexing (OFDM) communication or Clear Channel Assessment (CCA) range. Activating legacy protection may include transmitting an instruction to use legacy protection to one or more STAs in the WLAN, for example STAs communicating via OFDM. The instruction may be in the form of an enhanced rate physical layer (ERP) element of a wireless beacon. The instruction may instruct each wireless STA of the WLAN to precede OFDM transmissions to the AP with a second DSSS signal, which may include an Request to Send (RTS) frame, a Complementary Code Keying (CCK) signal, or a combination thereof.

For example when the DSSS STA cannot establish a communication link with an AP in the first instance, the AP may periodically transmit an OFDM signal that sets a Network Allocation Vector (NAV) period for a STA of the WLAN. The AP may subsequently monitor for a DSSS signal from the STA during the NAV period. Setting the NAV period may allow the AP to detect a DSSS transmission from a STA, such as by reducing/eliminating the number of collisions with the DSSS transmission from the intended STA during the NAV period. The AP may set the length of the NAV period based on an average window contention size, e.g., by adjusting the NAV period starting from the average window contention size up or down based on whether any DSSS transmissions are received, effects of additional overhead imposed on the system, etc. The OFDM signal may include a clear to send (CTS) frame, for example addressed to any node in the WLAN, e.g., a node other than the STA. In this way, the AP may clear or free up the wireless medium for a time specified in the CTS.

An AP may transmit an OFDM signal indicating a NAV period associated with a remote station initial access period. The AP may then receive a DSSS transmission from a remote STA during the remote station initial access period, for example, because other transmissions, e.g., OFDM transmissions from other STAs, are restricted during the remote station initial access period. The AP may transmit a DSSS signal that announces the OFDM signal prior to transmitting the OFDM single. The OFDM signal may include a CTS frame, for example, addressed to any node, for example, to free up resources for potential DSSS transmissions from one or more remote STAs. The AP may then transmit an instruction to use legacy protection within the WLAN of the AP based on the received DSSS transmission. The AP may also discontinue periodic transmission of the OFDM signal in response to the activation of legacy protection in the WLAN.

The AP may transmit a Clear to Send (CTS) frame at an OFDM rate in response to receiving the first DSSS signal, wherein the CTS frame initiates a DSSS transmit window associated with remote station initial access. Additionally or alternatively, the AP may transmit a Contention Free End (CF-End) frame at the OFDM rate, wherein the CF-End frame terminates the DSSS transmit window and initiates an OFDM transmit window. Additionally or alternatively, the AP may transmitting a Clear to Send (CTS) frame at a DSSS rate in response to receiving the first DSSS signal, wherein the CTS frame initiates an OFDM transmit window. A Contention Free End (CF-End) frame may be transmitted at the DSSS rate, wherein the CF-End frame terminates the OFDM transmit window.

A wireless STA may receive an indication of a NAV period associated with remote station initial access, monitor for radio transmissions during the indicated NAV period, and transmit a DSSS signal during the indicated NAV period based on the monitoring. The wireless STA may determine that the indicated NAV period is associated with the remote station initial access based on an absence of detected radio transmissions to an AP during the indicated NAV period. The wireless STA may further determine that the wireless STA is a remote STA based on an absence of detected radio transmissions to an AP during the indicated NAV period. The wireless STA may adjust a backoff window of the wireless STA based on the determination that the wireless STA is a remote STA. The wireless STA may transmit the DSSS signal based on the determination that the wireless STA is a remote STA. The wireless STA may receive an instruction to use legacy protection within a WLAN of the AP in response to transmitting the DSSS signal.

A wireless communications device may include means for receiving an indication of a NAV period associated with remote station initial access, means for monitoring for radio transmissions during the indicated NAV period, and means for transmitting a DSSS signal during the indicated NAV period based on the monitoring.

A wireless communications device may include a receiver to receive an indication of a NAV period associated with remote station initial access, an access manager to monitor for radio transmissions during the indicated NAV period, and a DSSS communications manager to transmit a DSSS signal during the indicated NAV period based on the monitoring.

A computer program product may include a non-transitory computer-readable medium storing instructions executable by a processor to receive an indication of a NAV period associated with remote station initial access, and monitor for radio transmissions during the indicated NAV period. The non-transitory computer-readable medium may also store instructions executable by a processor to transmit a DSSS signal during the indicated NAV period based on the monitoring.

Further scope of the applicability of the described methods and apparatuses will become apparent from the following detailed description, claims, and drawings. The detailed description and specific examples are given by way of illustration only, since various changes and modifications within the scope of the description will become apparent to those skilled in the art.

### BRIEF DESCRIPTION OF THE DRAWINGS

A further understanding of the nature and advantages of the present disclosure may be realized by reference to the following drawings. In the appended figures, similar components or features may have the same reference label. Further, various components of the same type may be distinguished by following the reference label by a dash and a second label that distinguishes among the similar components. If only the first reference label is used in the specification, the description is applicable to any one of the similar components having the same first reference label irrespective of the second reference label.

FIG. 1 shows a block diagram of a wireless communications system, in accordance with various embodiments;

FIG. 2 shows a block diagram of an exemplary wireless communications system that includes an OFDM coverage area and a DSSS coverage area, in accordance with various embodiments;

FIG. 3 shows a block diagram of an exemplary enhanced rate physical layer (ERP) protection element used to activate legacy protection, in accordance with various embodiments;

FIG. 4 shows an example of communications for activating legacy protection between an AP and two STAs, in accordance with various examples;

FIG. 5 shows a timing diagram of communications between an AP and two STAs for activating legacy protection, in accordance with various embodiments;

FIG. 6 shows a block diagram of an example of an AP for activating legacy protection, in accordance with various embodiments;

FIG. 7 shows a block diagram of an example of a STA for activating legacy protection, in accordance with various embodiments;

FIG. 8 shows a block diagram of another example of an AP for activating legacy protection, in accordance with various embodiments;

FIG. 9 shows a block diagram of another example of a STA for activating legacy protection, in accordance with various embodiments; and

FIGS. 10-12 show flowcharts of methods for activating legacy protection based on receiving a DSSS signal from a wireless station, in accordance with various embodiments.

FIG. 13 is a timing diagram showing an example of STA access;

FIG. 14 is a timing diagram showing an example of STA access;

FIG. 15 is a timing diagram showing an example of STA access;

FIG. 16 is a timing diagram showing an example of STA access;

FIG. 17 is a timing diagram showing an example of STA access;

FIG. 18 is a timing diagram showing an example of STA access;

FIG. 19 is a timing diagram showing an example of wideband transmit opportunity;

FIG. 20 shows a block diagram of a device of a method for initiating a wideband transmit opportunity; and

FIG. 21 shows a flowchart of a method for initiating a wideband transmit opportunity.

### DETAILED DESCRIPTION

The described features generally relate to one or more improved systems, methods, or apparatuses for activating legacy protection based on receiving a Direct Sequence Spread Spectrum (DSSS) signal from a station (STA). An access point (AP) may receive a first DSSS signal from a STA, and based at least in part on the received first DSSS signal, activate legacy protection in the wireless local area network (WLAN) served by the AP. The AP may compare a received signal strength of the first DSSS signal to a threshold and activate legacy protection based on the comparison, e.g., if the received signal strength is less than a threshold, indicating that the STA is beyond Orthogonal Frequency Division Multiplexing (OFDM) communication or Clear Channel Assessment (CCA) range. In this way, the AP may not unnecessarily activate legacy protection, for instance, when a STA in OFDM range is communicating via DSSS or when no STA is outside of OFDM communication or CCA range. By enabling legacy protection in the WLAN, the AP may enable a DSSS STA, which may be beyond OFDM range of the AP, to communicate with the AP more effectively, e.g., by establishing a connection more quickly, improving quality of the connection, etc. The described techniques may be particularly useful when there is heavy OFDM traffic in a WLAN, which may prevent or inhibit remote DSSS communications from being received by an AP.

Activating legacy protection may include transmitting an instruction to use legacy protection to one or more STAs in the WLAN, for example STAs communicating via OFDM. The instruction may be in the form of an enhanced rate physical layer (ERP) protection element of a wireless beacon, for example, transmitted by the AP. Legacy protection may invoke the use of a request to send (RTS)/clear to send (CTS) scheme where each device in the WLAN first requests access to the wireless medium, and upon receiving permission for access, for example from an AP, can then access the wireless medium. For example, when legacy protection is activated, each STA of the WLAN may precede OFDM transmissions to the AP with an RTS frame (i.e., a DSSS signal), a Complementary Code Keying (CCK) signal, or a combination thereof.

The AP may periodically transmit an OFDM signal that sets a NAV period (e.g., a remote station initial access period) for a STA of the WLAN, such as in a CTS frame that is addressed to a node in the WLAN, e.g., to the AP itself or to another node. In this way, the AP may clear the wireless medium for a time specified in the CTS. The AP may subsequently monitor for a DSSS signal from a STA during the NAV period (remote station initial access period). Setting the NAV period may allow the AP to detect a DSSS transmission from a STA, such as by reducing/eliminating the number of collisions with the DSSS transmission, e.g., from OFDM transmissions in the WLAN, from the intended STA during the NAV period. The AP may then transmit an instruction to use legacy protection within the WLAN of the AP based on the received DSSS transmission. The AP may also discontinue periodic transmission of the OFDM signal in response to the activation of legacy protection in the WLAN.

The AP may transmit a DSSS signal that announces the OFDM signal prior to transmitting the OFDM signal. The DSSS STA may then synchronize with the AP and transmit a DSSS packet during the NAV period when it did not receive the OFDM signal.

A STA may receive an indication of a NAV period associated with remote station initial access, monitor for radio transmissions during the indicated NAV period, and transmit a DSSS signal during the indicated NAV period based on the monitoring. The STA may determine that the indicated NAV period is associated with the remote station initial access based on an absence of detected radio transmissions to an AP during the indicated NAV period, and subsequently transmit a DSSS signal. The STA may subsequently receive an instruction to use legacy protection within the WLAN of the AP in response to transmitting the DSSS signal.

The following description provides examples and is not limiting of the scope, applicability, or configuration set forth in the claims. Various embodiments may omit, substitute, or add various procedures or components as appropriate. For instance, the methods described may be performed in an order different from that described, and various steps may be added, omitted, or combined. Also, features described with respect to certain embodiments may be combined in other embodiments. As referred to herein, a WLAN connection or link may be synonymous with a Wi-Fi, Wi-Fi Direct or Wi-Fi-P2P connection or group, Wi-Fi Display, Miracast, or other WLAN communication technologies. For the purposes of explanation, the described methods, systems, and devices refer specifically to WLAN; however, other radio communication or access technologies may be compatible with and implemented using the described techniques.

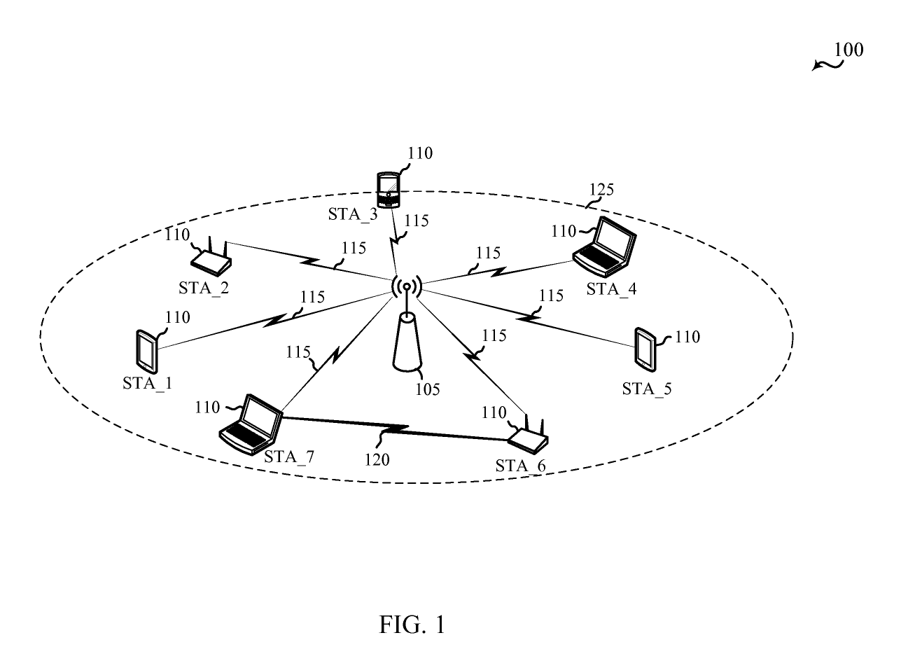

Referring first to FIG. 1, a block diagram illustrates a network 100 that may be an example of a WLAN or Wi-Fi network such as, e.g., a network implementing a version of the IEEE 802.11 family of standards. The network 100 may include an access point (AP) 105 and one or more wireless stations (STAs 110) labeled as STA_1 through STA_7. The wireless devices may include mobile handsets, personal digital assistants (PDAs), other handheld devices, netbooks, notebook computers, tablet computers, laptops, desktop computers, display devices (e.g., TVs, computer monitors, etc.), printers, etc. While only one AP 105 is illustrated, the network 100 may have multiple APs 105. Each of the STAs 110, which may also be referred to as a wireless station, a mobile station (MS), a mobile device, an access terminal (AT), a user equipment (UE), a subscriber station (SS), or a subscriber unit, may associate and communicate with an AP 105 via a communication link 115. Each AP 105 has a coverage area 125 such that STAs 110 within that area can typically communicate with the AP 105. The STAs 110 may be dispersed throughout the coverage area 125. Each STA 110 may be stationary or mobile.

Although not shown in FIG. 1, a STA 110 can be covered by more than one AP 105 and can therefore associate with one or more APs 105 at different times. A single AP 105 and an associated set of stations may be referred to as a basic service set (BSS). An extended service set (ESS) is a set of connected BSSs. A distribution system (DS) (not shown) is used to connect APs 105 in an extended service set. A coverage area 125 for an AP 105 may be divided into sectors making up only a portion of the coverage area (not shown). The network 100 may include APs 105 of different types (e.g., metropolitan area, home network, etc.), with varying sizes of coverage areas and overlapping coverage areas for different technologies. Although not shown, other wireless devices can communicate with the AP 105.

While the STAs 110 may communicate with each other through the AP 105 using communication links 115, each STA 110 may also communicate directly with one or more other STAs 110 via a direct wireless communication link 120. Two or more STAs 110 may communicate via a direct wireless communication link 120 when both STAs 110 are in the AP coverage area 125, when one STA 110 is within the AP coverage area 125, or when neither of the STAs 110 is within the AP coverage area 125 (not shown). Examples of direct wireless communication links 120 may include Wi-Fi Direct connections, connections established by using a Wi-Fi Tunneled Direct Link Setup (TDLS) link, and other P2P group connections. The STAs 110 and APs 105 in these examples may communicate according to the WLAN radio and baseband protocol including physical (PHY) and medium access control (MAC) layers from IEEE 802.11, and its various versions including, but not limited to, 802.11b, 802.11g, 802.11a, 802.11n, 802.11ac, 802.11ad, 802.11ah, etc. In other implementations, other peer-to-peer connections or ad hoc networks may be implemented in network 100.

One or more of STAs 110 may be configured to communicate with the AP 105 using different communications technologies, such as DSSS and OFDM (e.g., an 802.11b/g enabled device). The AP 105 may simultaneously support both DSSS and OFDM communications in network 100 with one or more STAs 110 more effectively with the techniques described herein. In one example, AP 105 may receive a first DSSS signal from a STA 110, for example STA_1, and based at least in part on the received first DSSS signal, activate legacy protection in network 100, e.g., by transmitting an instruction to all STAs 110 in network 100, e.g., to STA_1 through STA_7. Legacy protection may include use of an RTS/CTS scheme where each STA 110 in the network 100 first requests access to the wireless medium (with an RTS frame to the AP 105), and upon receiving permission for access (through a received CTS frame), for example from AP 105, can then access the wireless medium and transmit data.

The AP 105 may compare a received signal strength of the first DSSS signal to a threshold and activate legacy protection based on the comparison, e.g., if the received signal strength is less than a threshold, indicating that the STA 110 is beyond OFDM communication range. The instruction to use legacy protection may instruct each STA 110 of the network 100 to precede transmissions (particularly OFDM transmissions) to the AP 105 with a second DSSS signal, which may include a Request to Send (RTS) frame or a Complementary Code Keying (CCK) signal. In this way, interference in network 100 may be reduced by allowing the DSSS STA_1 110 to detect and coordinate transmission of DSSS signals around OFDM transmissions from other STAs 110, such as STA_2 through STA_7. As a result, the DSS S STA_1 110 may more successfully communicate via DSSS with the AP 105.

The AP 105 may periodically transmit an OFDM signal that sets a Network Allocation Vector (NAV) period for STAs 110 in network 100, e.g., to STA_2 through STA_7. The AP 105 may subsequently monitor for a DSSS signal from the STA_1 110 during the NAV period. Setting the NAV period may allow the AP 105 to detect a DSSS transmission from STA_1 110, such as by reducing/eliminating the number of collisions with the DSSS transmission from STA_1 110 during the NAV period with other transmissions, e.g., OFDM transmissions, from STA_2 through STA_7 110. The AP 105 may transmit the OFDM signal via a clear to send (CTS) frame, for example addressed to a node or STA, e.g., other than the STA_1 110, to free up the wireless medium for a time specified in the CTS. In this way, the AP 105 may detect DSSS communications from one or more STAs 110 that are out of OFDM communication range with the AP 105. Upon detecting a DSSS transmission from one or more STAs 110, the AP 105 may then enable legacy protection across network 100, by instructing STAs 110 of network 100 to use an RTS/CTS or similar access scheme.

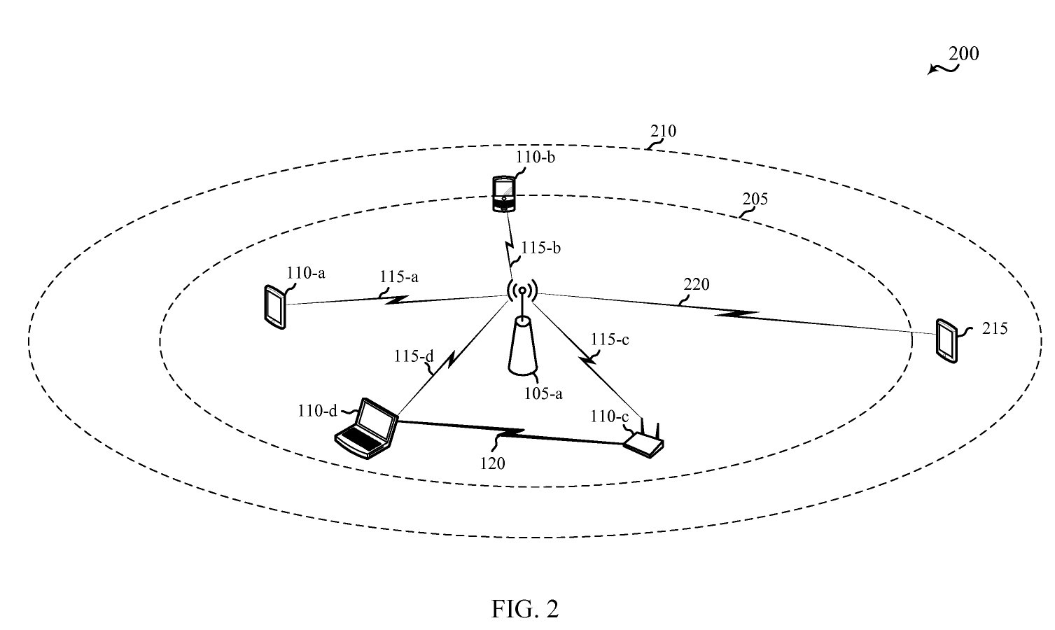

Referring now to FIG. 2, a network, and more particularly a WLAN 200, includes an AP 105-a in communication with STAs 110-a through 110-d via communication links 115-a through 115-d and with STA 215 via communication link 220. AP 105-a and STA 110-a through 110-d and 210 may be examples of AP 105 and STAs 110 described above in reference to FIG. 1. Furthermore, WLAN 200 may be an example of or a portion of network 100 described in reference to FIG. 1. STAs 110-a through 110-d may be located within coverage area 205 of AP 105-a, which may represent an OFDM coverage area such that communications across communication links 115-a through 115-d may be OFDM communications. STA 215, which may also be referred to as a remote station or STA 215, may be located beyond OFDM coverage area 205 but within coverage area 210 of AP 105-a, which may represent a DSSS coverage area, such that communication link 220 may support DSSS communications with AP 105-a. Coverage area 210 may be an example of coverage area 125 described in reference to FIG. 1.

One or more of STAs 110-a through 110-b may communicate with the AP 105-a via communication links 115-a through 115-d via OFDM. Simultaneously, the STA 215 may attempt to communicate with AP 105-a via communication link 220 using DSSS, as it may be outside of OFDM coverage area 205. The STA 215 may be configured to communicate via both DSSS (e.g., at 1 or 2 Mbps) when it is out of OFDM coverage area 205 and OFDM (e.g., up to 54 Mpbs) when it is located within OFDM coverage area 205 (e.g., a 802.11b/g enabled device). The STA 215 may experience delay or decreased communication performance (e.g., decreased data rate, throughput, latency, etc.) with the AP 105-a due to interference from one or more OFDM communications over communication links 115-a through 115-d. This may particularly be the case when the STA 215 is outside of the OFDM coverage area 205, as it may not detect the OFDM communications via communication links 115-a through 115-d, and so may not be able to correctly time transmission of an initial connection request message to the AP 105-a.

WLAN 200 may represent a home WLAN, with STAs 110-a through 110-b being located inside the home, and STA 215 being located outside of the home. STAs 110-a through 110-d may be mobile devices, printers, electronic displays, laptops, tablets, etc., located within the home, e.g., within an OFDM coverage area 205. STA 215, which may be a mobile device such as a smart phone, may attempt to access WLAN 200 after it moves outside of the home (e.g., in the back yard), which may be outside of an OFDM coverage area 205 of the home AP 105-a. As a result, STA 215, which may be forced to communicate with the AP 105-a via DSSS because it is too far away to implement OFDM communications, may experience delay or may not even be able to access WLAN 200 due to OFDM traffic inside the house. Furthermore, because STA 215 is out of OFDM coverage area 205, STA 215 may not be able to detect OFDM transmissions in the WLAN 200. Accordingly the STA 215 may experience a good quality of service when there is no OFDM traffic at one instant, and then in the next instant may not be able to connect to the WLAN 200 due to increased (undetected) OFDM traffic.

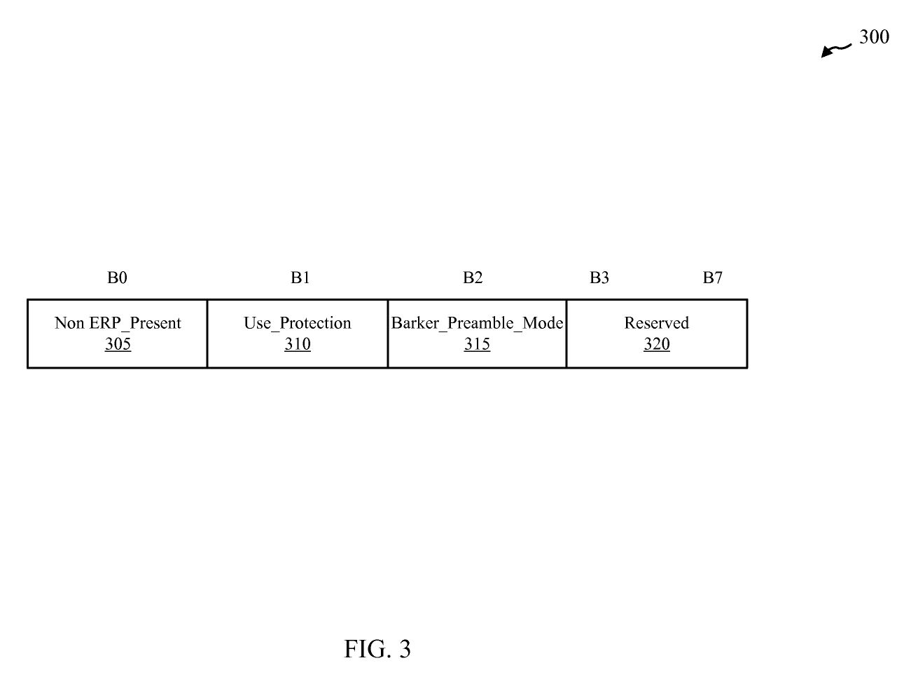

To improve communication performance for the STA 215, the AP 105-a may activate legacy protection in WLAN 200 based on receiving a first DSSS signal from STA 215. The AP 105-a may activate legacy protection by transmitting an instruction to STAs 110-a through 110-d and in some cases STA 215. The instruction may be in the form of an enhanced rate physical layer (ERP) protection element, for example of a wireless beacon transmitted/broadcasted by the AP 105-a. The ERP protection element will be described in greater detail with reference to FIG. 3 below.

Legacy protection may include an RTS/CTS scheme where each STA 110-a through 110-d and 210 first requests access to the wireless medium via sending an RTS frame to the AP 105-a. Upon receiving permission for access, for example via a CTS frame, for example from the AP 105-a, a STA can then access the wireless medium. For example, the instruction may instruct each STA 110-a through 110-b and 215 of the WLAN 200 to precede transmissions to the AP 105-a with a second DSSS signal, which may include an RTS frame, a Complementary Code Keying (CCK) signal, or other similar access request message. RTS/CTS may also be initiated by the AP 105-a in some cases. By activating legacy protection in the WLAN 200, STA 215 may more effectively access the wireless medium by seeing existing OFDM traffic in the WLAN 200 and coordinating messaging via communication link 220 with AP 105-a. The described techniques may also apply to more than one STA, such as STA 215, communicating via DSSS with AP 105-a outside of OFDM coverage area 205, for example via a priority scheme (e.g., first in time having priority, etc.).

Devices or STAs 110 enabled only for 802.11b communications (e.g., DSSS and not OFDM) may enter OFDM coverage area 205. These 802.11b STAs 110 may detect OFDM transmissions by STAs 110-a through 110-b, and so may not benefit from AP 105-a enabling legacy protection. In addition, enabling legacy protection may add overhead to WLAN 200 such that throughput, and general performance of communications over WLAN 200 may degrade. To prevent this unnecessary decrease in network performance, AP 105-a may compare a received signal strength of the first DSSS signal from STA 215 to a threshold and activate legacy protection based on the comparison, e.g., only if the received signal strength is less than a threshold, indicating that the STA 215 is actually beyond OFDM coverage area 205. The described techniques may be particularly useful when there is heavy OFDM traffic in WLAN 200, which may prevent or inhibit DSSS communications from STA 215 from being received by AP 105-a.

The AP 105-a may periodically transmit an OFDM signal that sets a NAV period (e.g., a remote station initial access period) for a STA 110 of WLAN 200, such as via a CTS frame that is addressed to a node in WLAN 200 (e.g., to the AP 105-a itself). In this way, the AP 105-a may clear the wireless medium for a time specified in the CTS. The AP 105-a may subsequently monitor for a DSSS signal from a STA outside of OFDM coverage area 205, such as STA 215, during the NAV period (remote station initial access period). Setting the NAV period may allow the AP 105-a to detect a DSSS transmission from STA 215, such as by reducing/eliminating the number of collisions with the DSSS transmission from OFDM transmissions via communication links 115-a through 115-d in WLAN 200 during the NAV period. The AP 105-a may then transmit an instruction to use legacy protection to one or more STAs 110-a through 110-d in WLAN 200 based on the received DSSS transmission. The AP 105-a may subsequently discontinue periodic transmission of the OFDM signal in response to the activation of legacy protection in the WLAN 200.

From the perspective of STA 215, STA 215 may receive an indication of a NAV period associated with remote station initial access from AP 105-a, monitor for radio transmissions during the indicated NAV period, and transmit a DSSS signal over communication link 220 during the indicated NAV period based on the monitoring. The STA 215 may determine that the indicated NAV period is associated with the remote station initial access based on an absence of detected radio transmissions, e.g., OFDM transmissions from STAs 110-a through 110-d to AP 105-a during the indicated NAV period, and subsequently transmit a DSSS signal. The STA 215 may subsequently receive an instruction to use legacy protection from AP 105-a.

In reference to FIG. 3, an ERP protection element 300 is shown that may be used to activate legacy protection in a WLAN, such as networks/WLANs 100 or 200 described in reference to FIG. 1 or 2. The ERP protection element 300 may include 8 bits, B0 through B7. B0 may include a Non ERP_Present field 305; B1 may include a Use_Protection flag 310; B2 may include a Barker_Preamble_Mode field 315; and B3 through B7 may be reserved, for example, for vendor-specific features or features to be included in later releases of the standard. The ERP protection element 300 may be transmitted by an AP to one or more STAs in a network as part of a beacon signal, such as by AP 105 to STA 110, 215, in network/WLAN 100, 200 as described above in reference to FIG. 1 or 2. In other implementations, the ERP protection element 300, or a similar message may be transmitted in a separate message, as part of another message, etc.

In current network operations, B0, e.g., the Non ERP_Present field 305, may be set to 1 when one or more older/non 802.11g STAs (e.g., STAs that do not support OFDM) associate with a serving network/WLAN 100, 200. B1, e.g., the Use_Protection flag 310, may be set to 1 when STAs that do not support OFDM communications enter the network/WLAN 100, 200. When B1 is set to 1, legacy protection may be enabled in the network/WLAN 100, 200. B2, e.g., the Barker_Preamble_Mode field 315, may be set to 1 if STAs associated with the network do not support a short preamble mode in communicating with an AP 105.

According to the present techniques, B1 may be used to activate legacy protection in a WLAN, such as by an AP 105 of network/WLAN 100, 200, upon receiving a DSSS signal from a station, such as STA 215, even though STA 215 may also support OFDM communications. In this way, no additional overhead may be used by the AP 105 in activating legacy protection according to the current techniques.

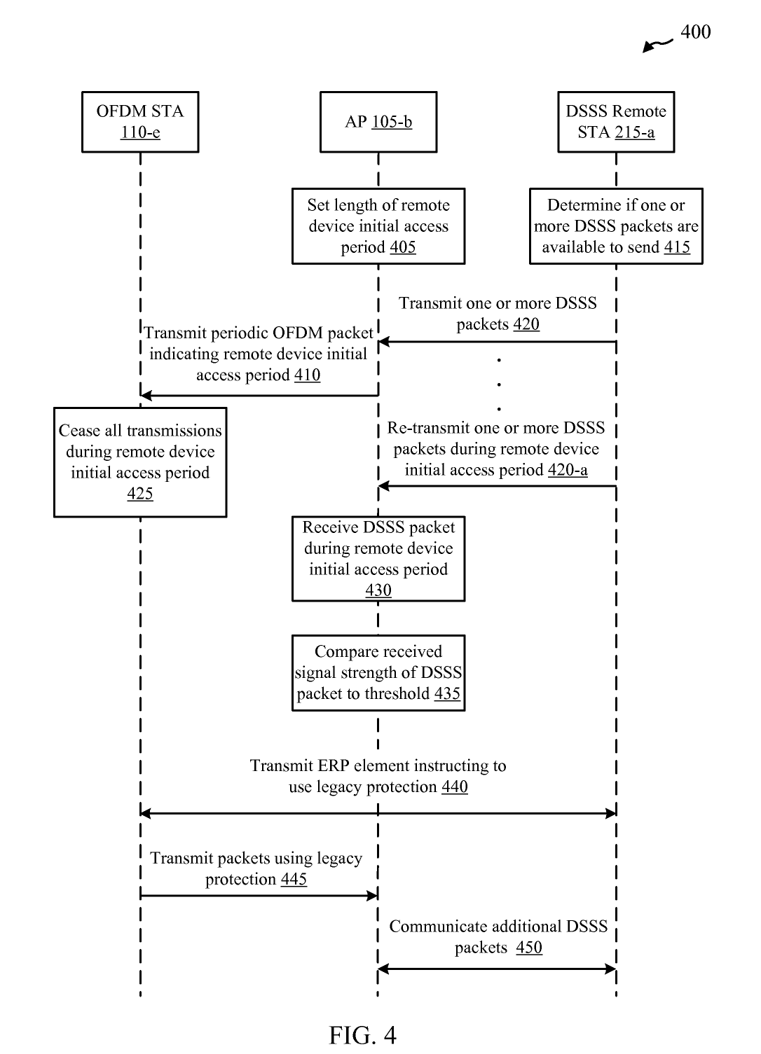

With reference to FIG. 4, communications 400 between an AP 105-b and two STAs 110, an OFDM STA 110-e and a DSSS remote station 215-a, are shown. AP 105-b and OFDM STA 110-e may be examples of AP 105 and STAs 110 described above in reference to FIG. 1 or 2. DSSS remote station 215-a may be an example of a STA 110 or STA 215 described above in reference to FIG. 1 or 2. The AP 105-b may communicate with one or more OFDM STA 110-e via communications links 115 and with the DSSS remote station 215-a via communication link 220 in a network/WLAN 100, 200 described in reference to FIG. 1 or 2.

The AP 105-b may first set at block 405 a length of a remote station initial access period, such as by setting the length of time of a NAV counter or period. The AP 105-b may set the length of the NAV period based on an average window contention size, e.g., by adjusting the NAV period from an average window contention size up or down based on whether any DSSS transmissions are received, effects of additional overhead imposed on the system, etc. The AP 105-b may then transmit at block 410 a periodic OFDM packet indicating the remote station initial access period to one or more OFDM STAs 110-e in an OFDM coverage area of the AP 105-b, such as OFDM coverage area 205 of FIG. 2. Transmitting the periodic OFDM packet may include transmitting a CTS frame that is addressed to any node, such as to the AP 105-b itself. In this way, the AP 105-a may clear the wireless medium for a time specified in the CTS, e.g., the remote station initial access period. The AP 105-b may subsequently monitor for a DSSS signal from a STA outside of OFDM coverage area 205, such as from DSSS remote station 215-a, during the remote station initial access period.

Upon receiving the periodic OFDM packet, the one or more OFDM STA 110-e may cease at block 425 all transmissions during the indicated remote station initial access period. By ceasing all transmissions during this period, the one or more OFDM STAs 110-e may better enable the AP 105-b to detect DSSS transmissions, for example from the DSSS remote station 215-a.

The AP 105-b may determine to perform blocks 405 and 410 based on conditions in a serving network of the AP 105-b. For example, the AP 105-b may receive a DSSS signal with a signal strength less than a threshold, for example, from a DSSS remote station 215-a, indicating that the DSSS remote station 215-a is outside of an OFDM coverage area (e.g., OFDM coverage area 205 of FIG. 2). Based on the received signal strength or other factors, such as subsequent connection failure with the DSSS remote station 215-a, detection of heavy OFDM traffic in the serving network of AP 105-b, or other conditions, the AP 105-b may determine that enabling legacy protection in the network would increase overall communication performance.

The periodic OFDM signal may be transmitted at block 410 by the AP 105-b within (e.g., before or after) a short interframe space (SIFS) of a beacon signal. The beacon signal may be addressed to and received by all devices and STAs in the network of the AP 105-b (e.g., one or more OFDM STAs 110-e and DSSS remote station 215-a). Upon receiving the beacon signal from the AP 105-b, the DSSS remote station may synchronize with the AP 105-b. As a result, by sending the OFDM frame and setting the remote station initial access period within a certain time of each other, e.g., an SIFS time, the DSSS remote station 215-a may have a much greater likelihood of aligning transmission of a DSSS packet with the remote station initial access period. In this way, particularly in a network with a lot of OFDM traffic, the AP 105-b may receive one or more DSSS packets from the DSSS remote station 215-a faster and more reliably, and in turn activate legacy protection more quickly to improve communication performance with the DSSS remote station 215-a.

Concurrently with the AP 105-b performing blocks 405 or 410, or before the OFDM STA 110-e ceases at block 425 all transmission during the remote station initial access period, the DSSS remote station 215-a may determine at block 415 if one or more DSSS packets are available or pending for transmission to the AP 105-b. The DSSS remote station 215-a may then transmit at block 420 one or more DSSS packets to the AP 105-b. The DSSS remote station 215-a may continue to re-transmit at block 420-a one or more DSSS packets to the AP 105-b until the transmission aligns with the remote station initial access period (e.g., OFDM STAs 110-e ceasing at block 425 all transmissions during the remote station initial access period). During the remote station initial access period, the wireless medium may be free to enable the AP 105-b to receive at block 430 one or more DSSS packets from the DSSS remote station 215-a. The AP 105-b may then compare at block 435 the received signal strength of the one or more received DSSS packets to a threshold. If the AP 105-b determines that the received signal strength of the one or more received DSSS packets is below a threshold, e.g., indicating that the DSSS remote station 215-a is outside of an OFDM coverage area (e.g., OFDM coverage area 205) of the AP 105-b, then the AP 105-b may transmit at block 440 an ERP protection element instructing OFDM device(s) 110-e to use legacy protection.

Upon receiving the ERP protection element instructing to use legacy protection from the AP 105-b, the one or more OFDM STAs 110-e may transmit at block 445 packets to the AP 105-b using legacy protection. The one or more OFDM STAs 110-e may implement legacy protection by preceding each OFDM transmission to the AP 105-b with a DSSS frame, such as an RTS frame or a CCK signal. The one or more OFDM STAs 110-e may then wait for a CTS message or other message from the AP 105-b granting access to the wireless medium before transmitting packets to the AP 105-b. By implementing legacy protection for the one or more OFDM STAs 110-e, communications between the OFDM device(s) 110-e and the AP 105-b may be visible to the DSSS remote station 215-a. This may allow the DSSS remote station 215-a to better coordinate communications with the AP 105-b, resulting in better and faster access to the wireless medium or increased communication performance with the AP 105-b. After the AP 105-b transmits at block 440 the ERP protection element, the DSSS remote station 215-a may communicate at block 450 additional DSSS packets.

AP 105-b may successfully receive a DSSS packet from the DSSS remote station 215-a without having to set at block 405 the remote station initial access period or transmit at block 410 the indication to the OFDM STA 110-e. The AP 105-b, upon receiving the DSSS packet from the DSSS remote station 215-a, the AP 105-b may compare at block 435 the received signal strength of the DSSS packet to a threshold. If the comparison indicates that the DSSS remote station 215-a is outside of the OFDM coverage area, the AP 105-b may then transmit at block 440 an ERP protection element instructing both the OFDM device(s) 110-e and the DSSS remote station 215-a to use legacy protection to both the OFDM device(s) 110-e and the DSSS remote station 215-a, to improve communication performance with the DSSS remote station 215-a. The OFDM STA 110-e may subsequently transmit at block 445 packets using legacy protection to the AP 105-b, and the DSSS remote station may communicate at block 450 additional DSSS packets to the AP 105-b.

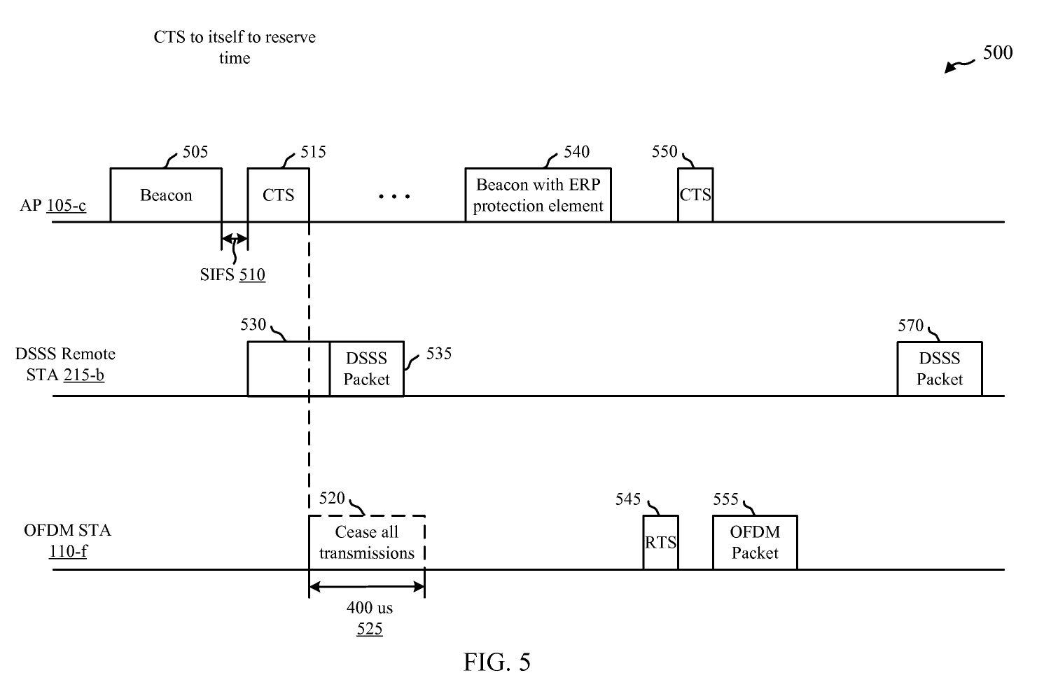

With reference to FIG. 5, a timing diagram illustrates communications 500 between an AP 105-c and two STAs, an OFDM STA 110-f and a DSSS remote station 215-b. AP 105-c and OFDM STA 110-f may be examples of AP 105 and STAs 110 described above in reference to FIG. 1, 2, or 4. DSSS remote station 215-b may be an example of STA 110 or STA 215 described above in reference to FIG. 1, 2, or 4. The AP 105-c may communicate with one or more OFDM STAs 110-f via communications links 115 and with the DSSS remote station 215-b via communication link 220 in a network/WLAN 100, 200 described in reference to FIG. 1 or 2.

The AP 105-c may transmit a beacon 505, for example upon receiving a DSSS packet, periodically, or based on some other input. An AP, such as AP 105-c, may periodically transmit a beacon to aid in synchronization across a network, for example every 100 ms. After a SIFS time 510, which may be of the order of 10 us, the AP 105-c may then transmit a CTS frame 515 that is addressed to the AP 105-c. The CTS frame 515, which may be an OFDM frame, may clear the wireless medium for a NAV period 525, which may correspond to a remote station initial access period, equal to approximately 400 us or other similar length. Implementing the remote station initial access period may thus not take up substantial overhead (approximately 250 us added for every beacon at 100 ms, or 0.25% per beacon period).

As the beacon transmitted 505 by the AP 105-c is addressed to all devices in a coverage area of the AP 105-c (e.g., coverage areas 125 or 210 of FIGS. 1 and 2), the DSSS remote station 215-b may receive the beacon and start a backoff window count down period 530. Backoff window count down period 530 may be of the order of 250 us or other similar value depending on network characteristics. The DSSS remote station 215-b may wait for the backoff window count down period 530 before transmitting one or more DSSS packets 535, for example, to synchronize with the AP 105-c.

Concurrently, the one or more OFDM STAs 110-f may receive the CTS frame transmitted 515 by the AP 105-c and cease all transmissions 520 for the indicated NAV period 525, which as shown is 400 us. The one or more OFDM STAs 110-f may start the NAV period or counter simultaneously with the DSSS remote station waiting to transmit during the backoff window count down period 530. As a result, at the end of the backoff window count down period 530, the DSSS remote station 215-b may transmit one or more DSSS packets 535 or preambles, which may occur during the NAV period 525 (e.g., when the OFDM device(s) 110-f are not transmitting). In this way, the wireless medium may be free for the AP 105-c to receive the one or more DSSS packets 535 transmitted by the DSSS remote station 215-b. The DSSS remote station may transmit the one or more DSSS packets/preambles using an access category voice (AC_VO) or video (AC_VI) message.

When the DSSS remote station 215-b is not yet in communication with the AP 105-c (e.g., accessing the network or WLAN served by AP 105-c for the first time), the DSSS remote station 215-b may use a backoff window count down period 530 equal to a contention window minimum value set by the AP 105-c or a smaller value to access the wireless medium during the NAV period 525. The DSSS remote station 215-b may postpone decrementing the backoff window count down period 530 until after the CTS frame 515 has been transmitted by the AP 105-c. The AP 105-c may indicate an addition NAV period in the beacon 505 to protect the CTS frame 515 from interface. Alternatively, the presence of the CTS frame 515 may be signaled by the AP 105-c in the beacon 505 when the DSSS remote station 215-b associates or re-associates with the AP 105-c.

For example, when the transmission of the CTS frame 515 is announced by the AP 105-c, and the DSSS remote station 215-b does not receive the CTS frame nor sees its Clear Channel Assessment (CCA) busy at the announced time, the DSSS remote station 215-b may conclude that it is a remote station. The DSSS remote station 215-b may then proceed to access the wireless medium by transmitting one or more DSSS packets 535 during the NAV period 525 using preferred access (when it is not already in recent DSSS communication with the AP 105-c). The preferred access may be based on the fact that all other transmissions in the served network are restricted during the NAV period 525, e.g., the remote station initial access period.

The AP 105-c, via the CTS frame 515, may modify the NAV period based on network performance considerations and success in detecting DSSS transmissions. The NAV period 525, also referred to herein as the remote station initial access period, may be initially set at a predetermined value, for example, based on a network implemented contention window size/backoff window size (e.g., the larger the backoff window, the longer the NAV period needs to be to allow for detection of a DSSS packet). The AP 105-c may adjust the NAV period 525 based on network performance. For example, if there is heavy traffic, such as OFDM traffic, in the network, the AP 105-c may reduce the length of the NAV period 525. Conversely, if, for example, there is minimal traffic in the network, the NAV period 525 may be increased in length to increase the probability that a DSSS transmission will be detected. Adjusting the NAV period 525 may be based on other factors, for example, if DSSS transmissions occur frequently in the network, the NAV period 525 may be increased to enable more frequent detection of DSSS signals. Additional or alternative factors may also be used to adjust the NAV period 525.

Once the AP 105-c receives a DSSS packet 535 or preamble from the DSSS remote station 215-b, the AP 105-c may, in some cases, compare the received signal strength of the one or more DSSS packets 535 to a threshold. If the comparison indicates that the DSSS remote station 215-b is outside of an OFDM coverage area (e.g., OFDM coverage area 205 of FIG. 2), the AP 105-c may transmit the next beacon with an ERP protection element 540, which may be an example of ERP protection element 300 described in reference to FIG. 3. The ERP protection element 540 may instruct the network devices, OFDM device(s) 110-f and DSSS remote station 215-b, to active legacy protection.

After receiving the beacon with the ERP protection element 540, the one or more OFDM device(s) 110-f may then communicate with the AP 105-c using legacy protection. The OFDM device(s) 110-f may first send an RTS frame 545 to the AP 105-c, wait to receive a CTS frame 550 transmitted by the AP 105-c, and then transmit one or more OFDM packets 555 if the CTS frame 550 indicates that access to the wireless medium is granted. Once legacy protection is enabled, the DSSS remote station 215-b may be able to detect transmissions from OFDM device(s) 110-f, such as RTS frame 545, CTS frame 550, and OFDM packet(s) 555. In scenarios where other higher level communications (e.g., higher data rates than OFDM) are taking place in the network, enabling legacy protection by the AP 105-c may enable the DSSS remote station 215-b to similarly detect these transmissions as well. The DSSS remote station 215-b may then be able to coordinate communications with the AP 105-c so as to improve access and communication performance with the AP 105-c, for example by minimizing collisions with OFDM transmissions from OFDM device(s) 110-f. The DSSS remote station 215-b may then communicate one or more DSSS packets 570 with the AP 105-c.

Different types of legacy protection may be used, for example, utilizing CCK signaling and the like.

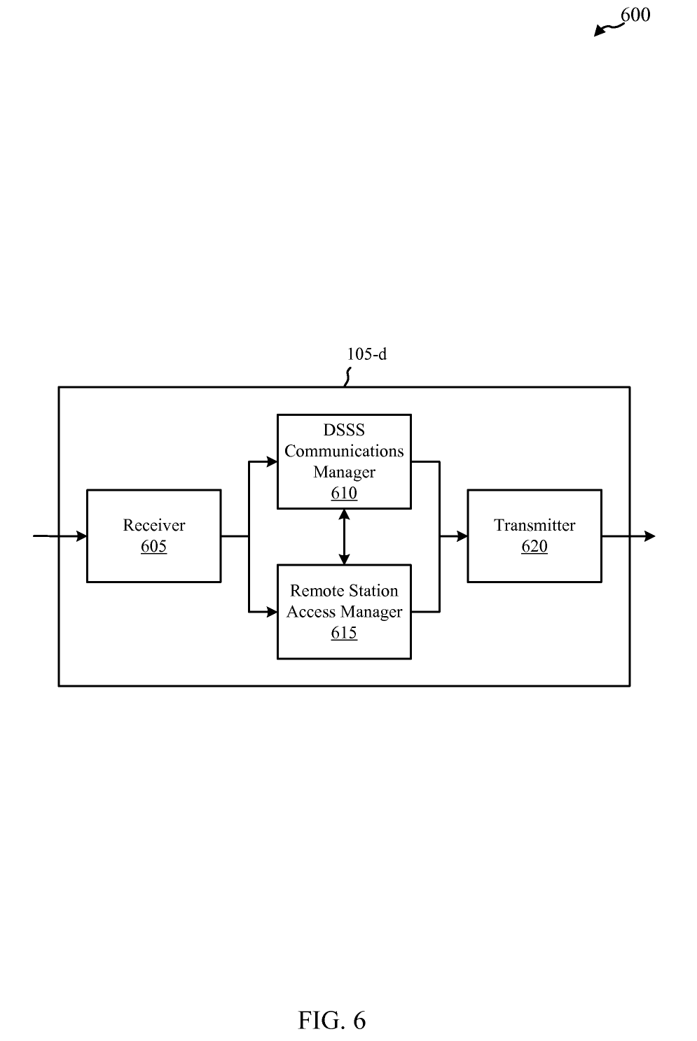

With reference to FIG. 6, a block diagram 600 illustrates an example of an AP 105-d that may be configured for activating legacy protection based on receiving a DSSS signal from a STA, in accordance with various embodiments. The AP 105-d may be an example of one or more aspects of APs 105 described above in reference to previous Figures. The AP 105-d may also be a part of or operate within network/WLAN 100 or 200 described in reference to FIG. 1, or 2, and may implement some or all of communications 400 or 500 described in reference to FIG. 4 or 5. The AP 105-d may include a receiver 605, a DSSS communications manager 610, a remote station access manager 615, or a transmitter 620, each of which may be communicably coupled with any or all of the other components.

The receiver 605 may be used to receive various types of data or control signals, such as DSSS and OFDM signals, over a wireless communications system such as network/WLAN 100 or 200 described in reference to FIG. 1 or 2. As such, the receiver 605, either alone or in combination with other components, may be means for communicating as described herein.

The transmitter 620 may be used to transmit various types of data or control signals, such as DSSS and OFDM signals, over a wireless communications system such as network/WLAN 100 or 200. As such, the transmitter 620, either alone or in combination with other components, also may be means for communicating.

The receiver 605 may receive a DSSS signal from a STA, such as from a DSSS remote station 215 described in reference to previous Figures. The receiver 605 may communicate the received DSSS signal to the DSSS communications manager 610 and the remote station access manager 615. The DSSS communications manager 610 may coordinate with the remote station access manager 615 and the transmitter 620 to activate legacy protection in the WLAN based on the received DSSS signal.

The DSSS communications manager 610 may derive a received signal strength from the received DSSS signal, and compare the derived value to a threshold signal strength. The threshold signal strength, for example, may be based on parameters of a WLAN served by the AP 105-d, and may be indicative of a coverage area of the AP 105-d, e.g., a DSSS coverage area 210 as described above in reference to FIG. 2. If the received single strength of the DSSS signal is less than the signal strength threshold, the DSSS communications manager 610 may determine that the remote DSSS STA 215 is outside of an OFDM coverage area, e.g., OFDM coverage area 205 of FIG. 2, and in the DSSS coverage area 210. The DSSS communications manager 610 may then communicate this information to the remote station access manager 615, which may determine to activate legacy protection in the WLAN based on the comparison.

The remote station access manager 615 may instruct the transmitter 620 to transmit an instruction to other devices in the WLAN, e.g., STAs 110 and the DSSS remote station 215, to activate legacy protection. The remote station access manager 615 may instruct the transmitter 620 to transmit an enhanced rate physical layer (ERP) protection element in a wireless beacon to activate legacy protection in the WLAN. The instruction to use legacy protection transmitted by the transmitter 620 may instruct each wireless station of the WLAN to precede OFDM transmissions to the AP 105-d with a second DSSS signal, such as an RTS frame or a CCK signal.

The remote station access manager 615 may configure an OFDM signal that sets a NAV period, which may be associated with a remote station initial access period, for one or more STAs of the WLAN. The remote station access manager 615 may configure the length of the NAV period based on an average contention window size, for example, implemented or used in the WLAN. The remote station access manager 615 may then communicate the OFDM signal to the transmitter 620 to be transmitted to a STA 110 in the WLAN. The receiver 605 may receive a DSSS signal from a remote station, such as DSSS remote station 215, during the NAV period. The receiver 605 may communicate the received DSSS signal to the DSSS communications manager 610 and the remote station access manager 615, which may then instruct the transmitter 620 to activate legacy protection in the WLAN based on the received DSSS signal. The remote station access manager 615 may instruct the transmitter 620 to discontinue periodic transmission of the OFDM signal in response to the use of legacy protection in the WLAN.

The remote station access manager 615 may instruct the receiver 605 to monitor for a DSSS signal from a remote station, during the NAV period. The DSSS communications manager 610 may, in coordination with the remote station access manager 615, instruct the transmitter 620 to transmit a DSSS signal that announces the OFDM signal, prior to transmitting the OFDM signal.

The OFDM signal configured by the remote station access manager 615 may include a CTS frame addressed to a node, for example a node other than the remote station (DSSS remote station 215). This may clear the wireless medium in the WLAN so that a DSSS signal may be received by receiver 605 without interference from other STAs 110 in the WLAN, e.g., communicating via OFDM. The remote station access manager 615 may instruct the transmitter 620 to transmit the OFDM signal within a short interframe space (SIFS) of a wireless beacon periodically transmitted by AP 105-d.

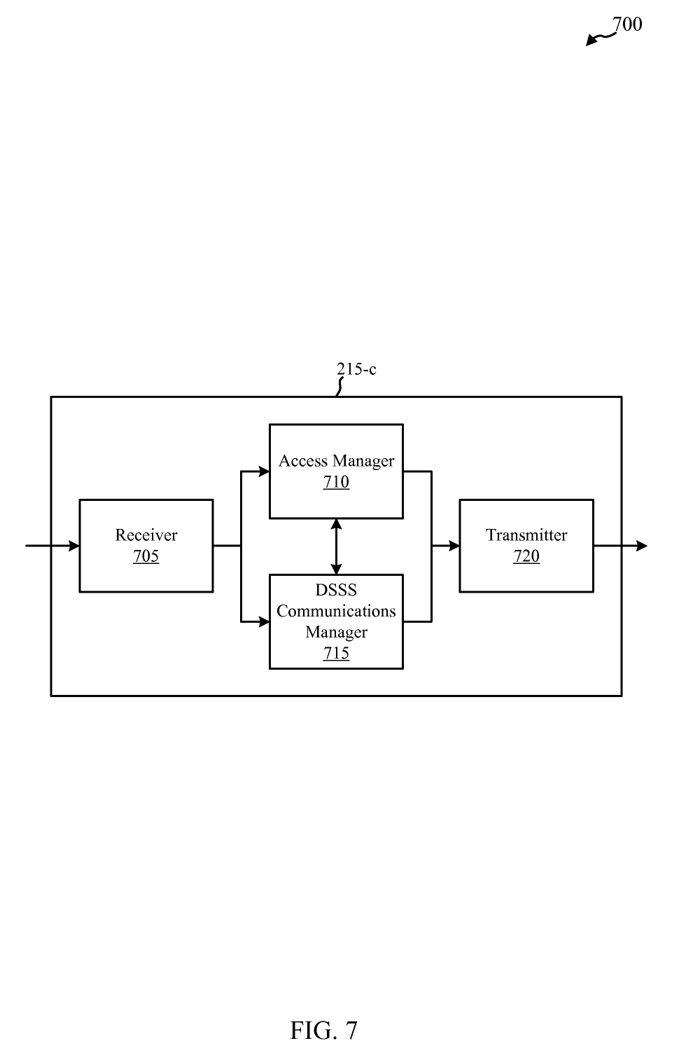

With reference to FIG. 7, a block diagram 700 illustrates an example of a DSSS remote station 215-c that may be configured for receiving an indication of a NAV period associated with a remote station initial access period and transmitting a DSSS signal during the indicated NAV period, in accordance with various embodiments. The DSSS remote station 215-c may be an example of one or more aspects of DSSS remote station 215 described above in reference to previous Figures. The DSSS remote station 215-c may also be a part of or operate within network/WLAN 100 or 200 described in reference to FIG. 1, or 2, and may implement some or all of communications 400 or 500 described in reference to FIG. 4 or 5. The DSSS remote station 215-c may include a receiver 705, an access manager 710, a DSSS communications manager 715, or a transmitter 720, each of which, in embodiments, may be communicably coupled with any or all of the other components.

The receiver 705 may be used to receive various types of data or control signals, such as DSSS or OFDM signals, over a wireless communications system such as network/WLAN 100 or 200 described in reference to FIG. 1 or 2. As such, the receiver 705, either alone or in combination with other components, may be means for communicating as described herein.

The transmitter 720 may be used to transmit various types of data or control signals, such as DSSS or OFDM signals, over a wireless communications system such as network/WLAN 100 or 200. As such, the transmitter 720, either alone or in combination with other components, also may be means for communicating.

The receiver 705 may receive a message containing an indication of a NAV period associated with a remote station initial access period, for example transmitted by an AP 105. The receiver 705 may communicate the received message to the access manager 710 and the DSSS communications manager 715. The access manager 710 may then instruct the receiver 705 to monitor for radio transmissions during the indicated NAV period. The receiver 705 may report that no radio transmissions are being received during the indicated NAV period to the access manager 710 and the DSSS communications manager 715. The access manager 710 may then instruct the DSSS communications manager 715 to transmit, via transmitter 720, a DSSS signal during the indicated NAV period. The receiver 705 may receive an instruction to use legacy protection within the current WLAN in response to the transmitter 720 transmitting the DSSS signal. The receiver 705 may communicate the instruction to the DSSS communications manager 715, which may subsequently implement and control legacy protection for the DSSS remote station 215-c, e.g., by instructing the transmitter 720 to precede all transmission with an RTS frame or the like.

The access manager 710 may determine, based on no detected radio transmissions during the NAV period reported from the receiver 705, that the NAV period is associated with a remote station initial access period, or that the DSSS remote station 215-c is a remote station. The access manager 710 may adjust a backoff window of the DSSS remote station 215-c based on the determination that the DSSS remote station 215-c is a remote station. The access manager 710 may instruct the DSSS communications manager 715 to transmit, via the transmitter 720, the DSSS signal based on the determination that the DSSS remote station 215-c is a remote station.

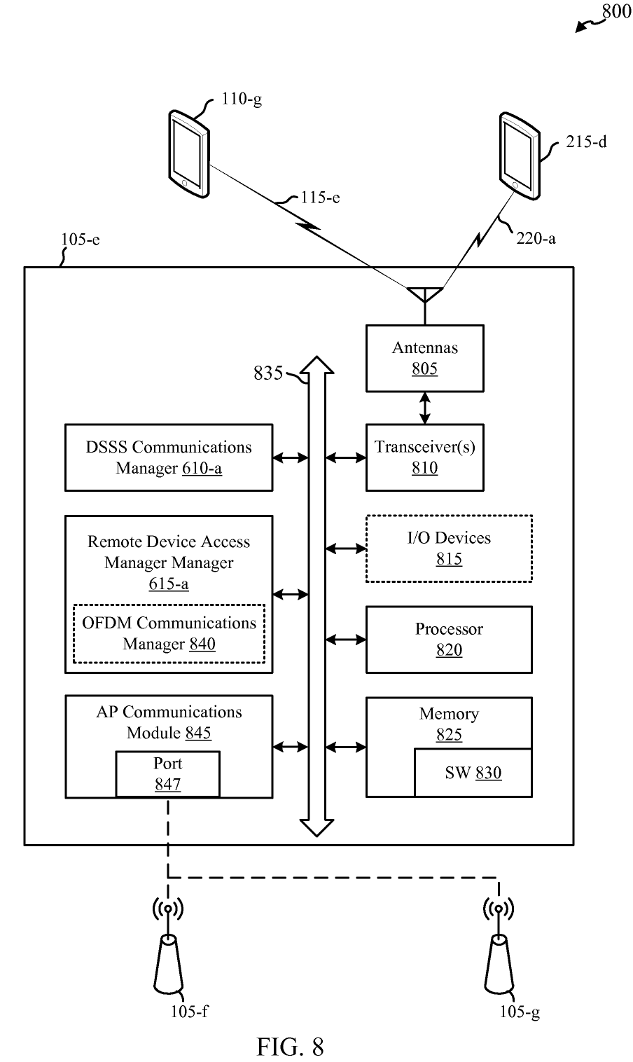

With reference to FIG. 8, a block diagram of an AP 105-e in a communication system 800 including a STA 110-g, a DSSS remote station 215-d, and two additional APs 105-f and 105-g is shown. The AP 105-e may be configured for activating legacy protection in communication system 800 based on receiving a DSSS signal, for example from DSSS remote station 215-d in accordance with various embodiments. The AP 105-e, and in some cases APs 105-f, 105-g, may be an example of one or more aspects of APs 105 described above in reference to previous Figures. The STA 110-g and the DSSS remote station 215-d may be examples of one or more aspects of STAs 110 and DSSS remote stations 215 described above in reference to previous Figures. The communication system 800 may include one or more aspects of networks/WLANs 100 or 200 described in reference to FIG. 1, or 2, and may implement some or all of communications 400 or 500 described in reference to FIG. 4 or 5. The AP 105-e may have any of various configurations and may be a fixed AP or a soft AP. The AP 105-e may, in some cases have an internal power supply (not shown), such as a small battery, to facilitate mobile operation, for example when AP 105-e is configured as a soft AP.

The AP 105-e may include antenna(s) 805, one or more transceiver(s) 810, I/O devices 815, a processor 820, and a memory 825, which each may be in communication, directly or indirectly, with each other, for example, via one or more buses 835. The transceiver 810 may be configured to communicate bi-directionally, via the antennas 805, with a STA 110-g via communication link 115-e and a DSSS remote station 215-d via communication link 220-a. The transceiver 810 and antennas 805 may be configured to communicate bi-directionally with other devices as well, such as other STAs 110 or other DSSS remote stations 215 via wired or wireless links, such as any of links 115, 220 of FIGS. 1 and 2, as described above. The transceiver 810 may include a modem configured to modulate the packets and provide the modulated packets to the antennas 805 for transmission, and to demodulate packets received from the antennas 805. The transceiver 810 may be configured to maintain multiple concurrent communication links using the same or different radio interfaces (e.g., Wi-Fi, cellular, etc.). The AP 105-e may include a single antenna 805, or the AP 105-e may include multiple antennas 805. The AP 105-e may be capable of employing multiple antennas 805 for transmitting and receiving communications in a multiple-input multiple-output (MIMO) communication system.

The AP 105-e may also include an AP communications manager 845, which may manage communications through a port 847 with other APs 105, such as APs 105-f and 105-g as shown in FIG. 8, over one or more infrastructure or backhaul communications links. For example, when AP 105-e is implemented as a soft AP, the AP communications manager 845 may communicate with other APs 105 via the transceiver 810 and antennas 805.

The memory 825 may include random access memory (RAM) and read-only memory (ROM). The memory 825 may store computer-readable, computer-executable software 830 containing instructions that are configured to, when executed, cause the processor 820 to perform various functions described herein. Alternatively, the software 830 may not be directly executable by the processor 820 but be configured to cause the computer (e.g., when compiled and executed) to perform functions described herein. The processor 820 may include an intelligent hardware device, e.g., a central processing unit (CPU), a microcontroller, an application specific integrated circuit (ASIC), etc.

According to the architecture of FIG. 8, the AP 105-e further includes a DSSS communications manager 610-a and a remote station access manager 615-a including an OFDM communications manager 840. The DSSS communications manager 610-a and the remote station access manager 615-a may implement the techniques describe above for activating legacy protection based on a received DSSS signal, as described in reference to previous Figures, and so for brevity will not be repeated here. The OFDM communications manager 840, as part of the remote station access manager 615-a, may implement and control OFDM communications of AP 105-e, for example, transmission of an OFDM signal indicating a NAV period associated with a remote station initial access period. The OFDM communications manager 840 may control other OFDM functionality, as described above in reference to FIG. 6, and so likewise, for the sake of brevity will not be repeated here. By way of example, these components of the AP 105-e may be in communication with some or all of the other components of AP 105-e via bus 835. Additionally or alternatively, functionality of these components may be implemented via the transceiver 810, as a computer program product stored in software 830, or as one or more controller elements of the processor 820. The DSSS communications manager 610-a, the remote station access manager 615-a or the OFDM communications manager 840 may be implemented as subroutines in memory 825/software 830, executed by the processor 820. These components may be implemented as sub-modules in the processor 820 itself.

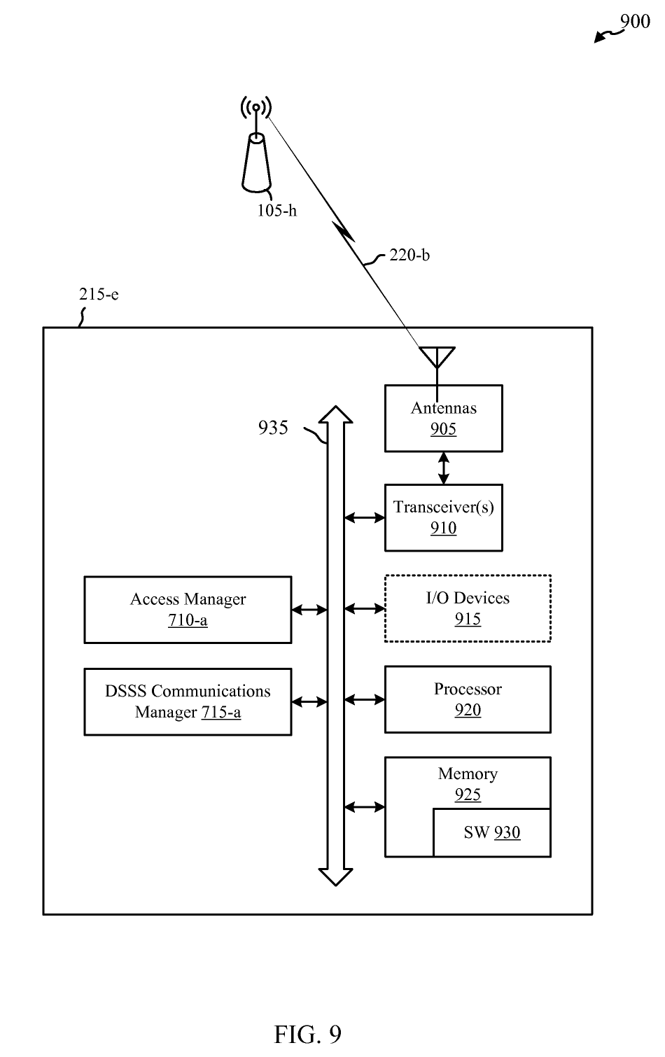

With reference to FIG. 9, a block diagram of a DSSS remote station 215-e in a communication system 900 including an AP 105-h is shown. The DSSS remote station 215-e may be configured for receiving an indication of a NAV period associated with a remote station initial access period and transmitting a DSSS signal during the indicated NAV period, in accordance with various embodiments. The DSSS remote station 215-e may be an example of one or more aspects of DSSS remote station 215 described above in reference to previous Figures. The AP 105-h may be an example of one or more aspects of APs 105 also described above in reference to previous Figures. The DSSS remote station 215-e may be a part of or operate within network/WLAN 100 or 200 or communication system 800 described in reference to FIG. 1, 2, or 8, and may implement some or all of communications 400 or 500 described in reference to FIG. 4 or 5. The DSSS remote station 215-e may have any of various configurations, such as personal computers (e.g., laptop computers, netbook computers, tablet computers, etc.), smartphones, cellular telephones, PDAs, wearable computing devices, digital video recorders (DVRs), internet appliances, gaming consoles, e-readers, display devices, printers, etc. The DSSS remote station 215-e may have an internal power supply (not shown), such as a small battery, to facilitate mobile operation.

The DSSS remote station 215-e may include antenna(s) 905, one or more transceiver(s) 910, I/O devices 915, a processor 920, and a memory 925, which each may be in communication, directly or indirectly, with each other, for example, via one or more buses 935. The transceiver 910 may be configured to communicate bi-directionally, via the antennas 905, with an AP 105-h via communication link 220-b, which may support both OFDM and DSSS communications. The transceiver 910 and antennas 905 may be configured to communicate bi-directionally with other devices as well, such as other STAs 110, other DSSS remote stations 215, or other APs 105 via wired or wireless links, such as any of links 115, 220 described in reference to previous Figures. The transceiver 910 may include a modem configured to modulate the packets and provide the modulated packets to the antennas 905 for transmission, and to demodulate packets received from the antennas 905. The transceiver 910 may be configured to maintain multiple concurrent communication links using the same or different radio interfaces (e.g., Wi-Fi, cellular, etc.). The DSSS remote station 215-e may include a single antenna 905, or the DSSS remote station 215-e may include multiple antennas 905. The DSSS remote station 215-e may be capable of employing multiple antennas 905 for transmitting and receiving communications in a multiple-input multiple-output (MIMO) communication system.

The memory 925 may include random access memory (RAM) and read-only memory (ROM). The memory 925 may store computer-readable, computer-executable software 930 containing instructions that are configured to, when executed, cause the processor 920 to perform various functions described herein. Alternatively, the software 930 may not be directly executable by the processor 920 but be configured to cause the computer (e.g., when compiled and executed) to perform functions described herein. The processor 920 may include an intelligent hardware device, e.g., a central processing unit (CPU), a microcontroller, an application specific integrated circuit (ASIC), etc.

According to the architecture of FIG. 9, the DSSS remote station 215-e further includes an access manager 710-a and a DSSS communications manager 715-a. The access manager 710-a and the DSSS communications manager 715-a may implement the techniques described above for receiving an indication of a NAV period associated with a remote station initial access period and transmitting a DSSS signal during the indicated NAV period, as described in reference to previous Figures, and so for brevity will not be repeated here. By way of example, these components of the DSSS remote station 215-e may be in communication with some or all of the other components of DSSS remote station 215-e via bus 935. Additionally or alternatively, functionality of these components may be implemented via the transceiver 910, as a computer program product stored in software 930, or as one or more controller elements of the processor 920. The access manager 710-a or the DSSS communications manager 715-a may be implemented as subroutines in memory 925/software 930, executed by the processor 920. These components may be implemented as sub-modules in the processor 920 itself.

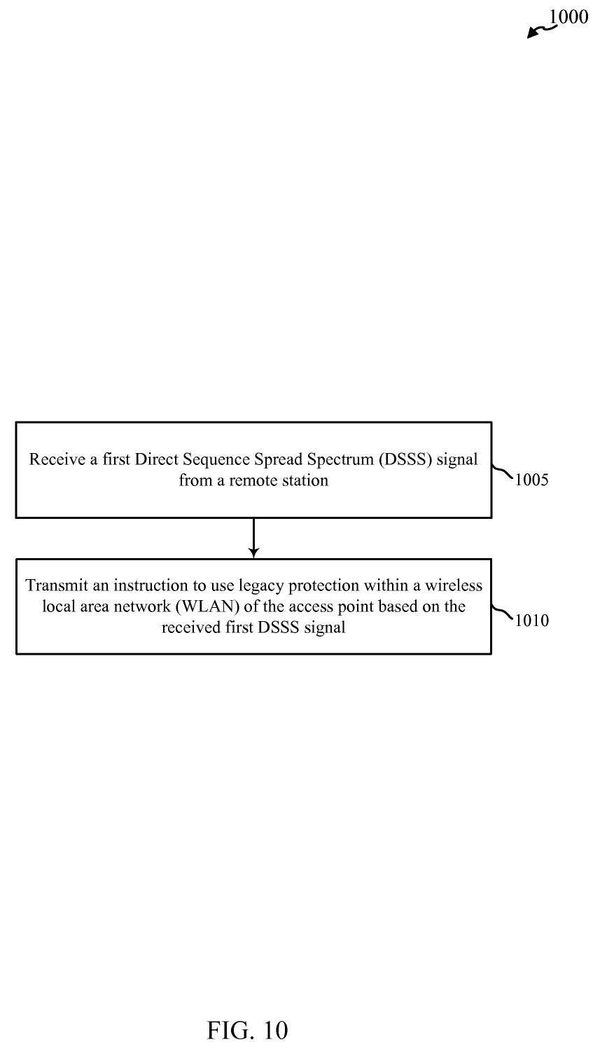

FIG. 10 is a flow chart illustrating one example of a method 1000 for activating legacy protection based on receiving a DSSS signal in accordance with various embodiments. For clarity, the method 1000 is described below with reference to one or more aspects of one of APs 105 or remote stations, e.g., DSSS remote station 215, described with reference to previous Figures. An AP 105 may execute one or more sets of codes to control the functional elements of the AP 105 to perform the functions described below.

At block 1005, AP 105, such as AP 105 of FIG. 6 or 8, may receive a first DSSS signal from a remote station, such as DSSS remote station 215 of FIG. 7 or 9.

At block 1110, the AP 105 may transmit an instruction to use legacy protection within a WLAN of the AP 105 based on the received first DSSS signal. The AP 105 may compare a received signal strength of the first DSSS signal to a threshold. If the comparison indicates that the remote station is beyond an OFDM coverage area (e.g., OFDM coverage 205 of FIG. 2), the AP 105 may then determine to activate legacy protection in the WLAN.

Thus, the method 1000 may provide for activating legacy protection in a WLAN based on receiving a DSSS signal. It should be noted that the method 1000 is just one implementation and that the operations of the method 1000 may be rearranged or otherwise modified such that other implementations are possible.

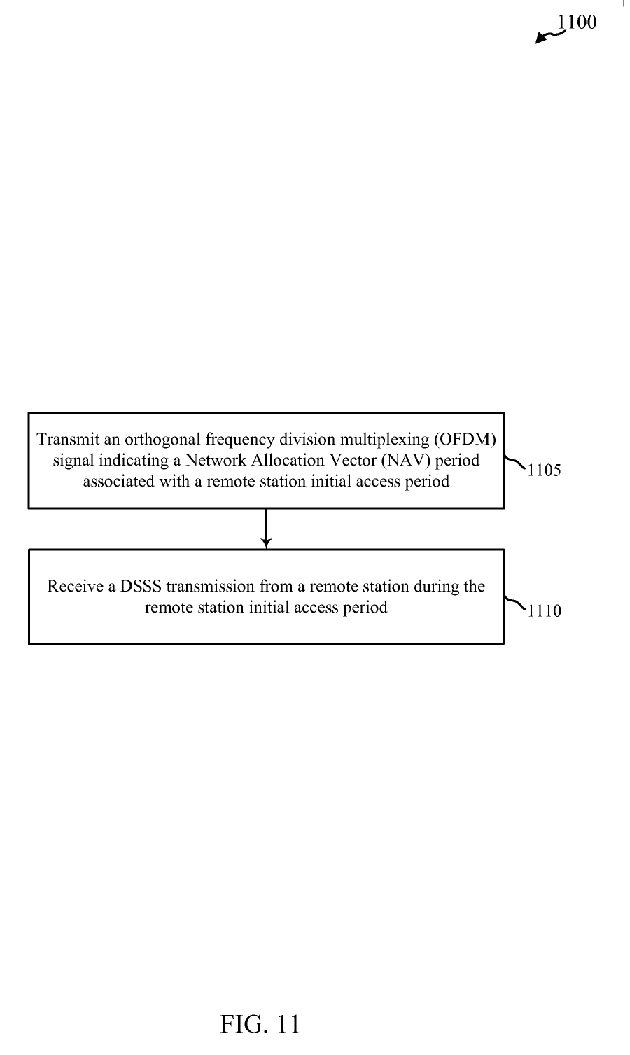

FIG. 11 is a flow chart illustrating one example of a method 1100 for receiving a DSSS signal during a remote station initial access period in accordance with various embodiments. For clarity, the method 1100 is described below with reference to one or more aspects of one of APs 105 or remote stations, e.g., DSSS remote station 215, described with reference to previous Figures. An AP 105 may execute one or more sets of codes to control the functional elements of the AP 105 to perform the functions described below.

At block 1105, AP 105, such as AP 105 of FIG. 6 or 8, may transmit an OFDM signal indicating a NAV period associated with a remote station initial access period.

At block 1110, the AP 105 may receive a DSSS transmission from a remote station, such as DSSS remote station 215 of FIG. 7 or 9, during the remote station initial access period. The AP 105 may transmit an instruction to use legacy protection within a WLAN of the AP 105 based on the received DSSS transmission.

Thus, the method 1100 may provide for receiving a DSSS signal during a remote station initial access period. It should be noted that the method 1100 is just one implementation and that the operations of the method 1100 may be rearranged or otherwise modified such that other implementations are possible.

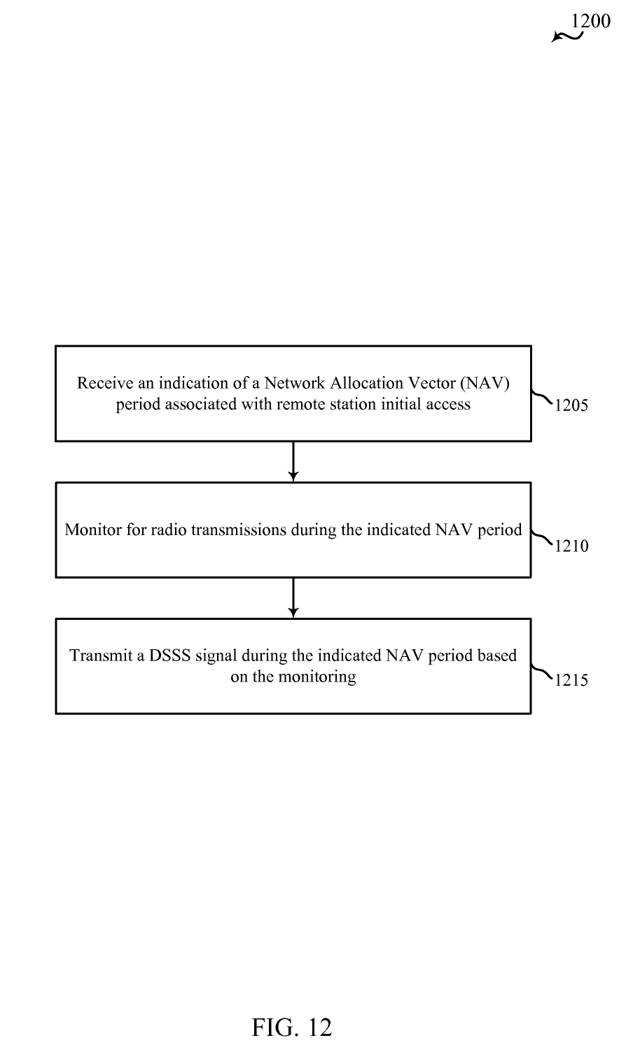

FIG. 12 is a flow chart illustrating one example of a method 1200 for transmitting a DSSS signal during a NAV period associated with remote device initial access in accordance with various embodiments. For clarity, the method 1200 is described below with reference to one or more aspects of one of remote stations, e.g., DSSS remote station 215, and APs 105, described with reference to previous Figures. A DSSS remote station 215 may execute one or more sets of codes to control the functional elements of the DSSS remote station 215 to perform the functions described below.

At block 1205, a STA, such as DSSS remote station 215 of FIG. 7 or 9, may receive an indication of a NAV period associated with remote station initial access, for example from an AP 105, such as AP 105 of FIG. 6 or 8.

At block 1210, the DSSS remote station 215 may monitor for radio transmissions during the indicated NAV period.

At block 1215, the DSSS remote station 215 may transmit a DSSS signal during the indicated NAV period based on the monitoring, e.g., if no other transmissions are detected during the NAV period.

Thus, the method 1200 may provide for transmitting a DSSS signal during a NAV period associated with remote device initial access. It should be noted that the method 1200 is just one implementation and that the operations of the method 1200 may be rearranged or otherwise modified such that other implementations are possible.

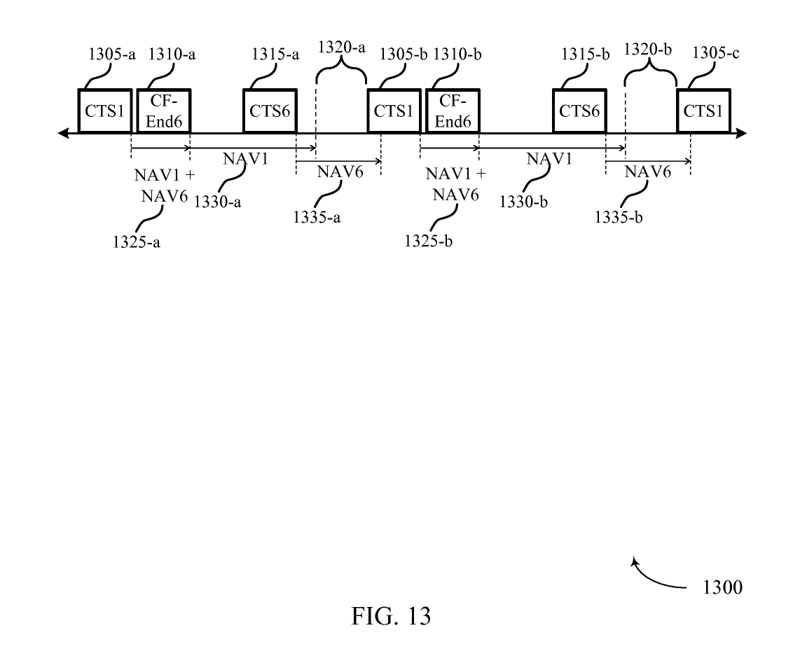

FIG. 13 is a timing diagram showing an example of STA1 access 1300. FIG. 13 may represent an exemplary remote device protection mechanism using the following definitions: a STA1 device may be a device (e.g., one of the STAs 110 described in the previous FIGs.) that can receive 1 Mbps (i.e. DSSS) frames from the AP 105, but not 6 Mbps (i.e. OFDM) frames; a STA6 device may be a device (e.g., one of the STAs 110 described in the previous FIGs.) that can receive 6 Mbps frames from the AP 105 (and therefore also 1 Mbps frames); a CTS1 1305 may be a CTS transmitted by the AP 105 at 1 Mbps; a CTS6 1315 may be a CTS transmitted by the AP 105 at 6 Mbps; a CF-End6 1310 may be a contention free end message transmitted by the AP 105 at 6 Mbps; a NAV1 1330 may be a NAV at STA1 devices; and a NAV6 1335 may be a NAV at STA6 devices. A STA1 device may be classified as a remote device. A device may be a STA1 device in two ways: either the device is an 802.11b-only device (which may imply that OFDM is not supported), or the device may support OFDM but be outside the range of 6 Mbps OFDM transmissions by the AP 105, including carrier detect CCA (CCA CD). The CCA CD range may be assumed to be about the same as the range of a 6 Mbps CTS, because a CTS is a short frame.

An AP 105 may create periods of time during which STA1 devices can access the medium without STA6 interference as follows. The AP 105 may transmit a CTS1 1305 followed by a CF-End6 1310. The CTS1 1305 may set a NAV at both STA1 and STA6 devices (NAV1+NAV6 1325). During CF-End6 1310, STA1 devices may keep their NAV set while STA6 devices may reset their NAV (resulting in NAV1 1330). Before the end of NAV1 1330, the AP 105 may transmit a CTS6 1315, which may set a NAV at STA6 devices (NAV6 1335), but not at STA1 devices. At the end of NAV1 1330, STA1 devices may continue to decrement their backoff and possibly transmit during interval 1320-a (so STA1 devices may access the medium during this interval). In the absence of a STA1 transmission, the AP 105 may transmit a CTS1 1305 before the end of NAV6, again followed by a CF-End6 1310, which may reset the NAV at STA6 devices, and the sequence may repeat.

Because STA1 devices may send less traffic, a NAV1 1330 may be longer than a NAV6 1335. NAV1 1330 may be a maximum possible NAV time of (e.g., 32 ms), which may imply about 3 NAV1/NAV6 sequences per 100 ms beacon period, and which also may imply that STA1 devices may be able to access the channel about 3 times per beacon period (which in many cases may be enough for STA1 devices based on an expected low throughput requirement).

Thus, the AP 105 may set a NAV at all STAs 110 in its range (e.g., the range of CTS1 1305) and then reset the NAV at STA6 devices, such that devices for which 6 Mbps transmissions are invisible keep their NAV set (STA1 devices). At the end of such a STA6-only period (e.g., NAV1 interval 1330), the AP 105 may set a NAV at the STA6 devices, but not the STA1 devices, so that any STA1 devices with traffic can access the medium without invisible interference from STA6 devices (e.g., during interval 1320). The AP 105 may then set a NAV at all devices and reset the NAV at STA6 devices to repeat the sequence.

A STA1 device may wake up from hibernation or sleep mode and may not be aware of the next STA1 access period. The STA1 device may wait for some period of time in order to receive a synchronization frame from the AP 105. This functionality may depend on knowledge about whether the AP 105 deploys the described remote device protection method and knowledge of the corresponding intervals. Power save wakeup issues may be reduced by decreasing the interval between CTS1 1305 and CTS6 1315. It is also possible that the AP 105 may reinforce NAV1 1330 before CTS6 1315, by sending another sequence CTS1 1305/CF-End6 1310 with a duration setting in the CTS1 1305 that covers until the originally scheduled CTS6 1315.

When a CTS1 1305 is received, a STA 110 may, by default classify as a STA1 device. When a CF-End6 1310 is received, a STA 110 may become a STA6 device. In other words, a STA 110 may be a STA1 device at one time and a STA6 device at other times (e.g., when the STA 110 is closer to the AP 105, or when the signal from the AP 105 is stronger).

Thus, as described herein, an AP 105 may transmit a CTS frame at an OFDM rate (e.g., 6 Mbps) in response to receiving a first DSSS signal, wherein the CTS frame is associated with initiating a DSSS transmit window (e.g., a NAV6 1335 associated with a STA1 access interval). The AP 105 may then transmit a CF-End frame at the OFDM rate, wherein the CF-End frame is associated with terminating the DSSS transmit window or initiating an OFDM transmit window.

Also, an AP 105 may also transmit a CTS frame at a DSSS rate (e.g., 1 Mbps) in response to receiving the first DSSS signal, wherein the CTS frame is associated with initiating an OFDM transmit window (e.g., a NAV1 1330 associated with a STA6 access interval). The AP 105 may then transmit a CF-End frame at the DSSS rate, wherein the CF-End frame is associated with terminating the OFDM transmit window.

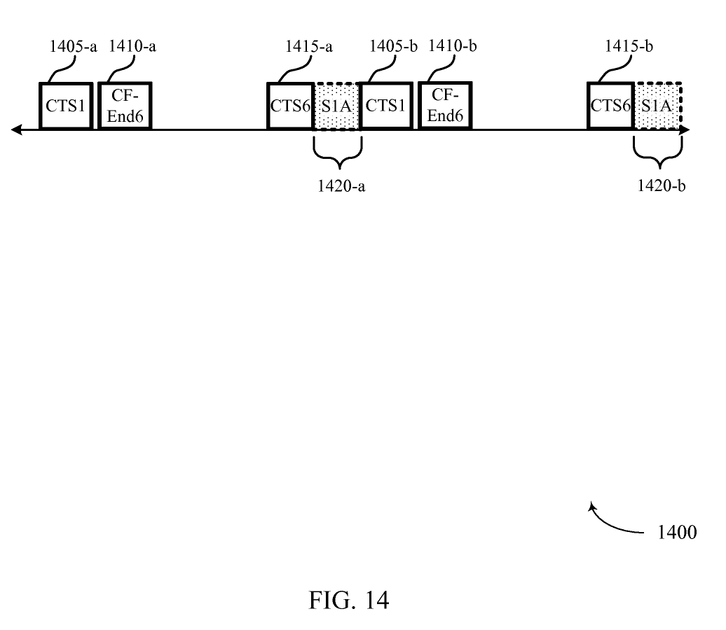

FIG. 14 is a timing diagram showing an example of STA1 access 1400. FIG. 14 may be an abstract depiction of aspects of FIG. 13. FIG. 14 may include a CTS1 1405, a CF-End6 1410, and a CTS6 1415, which may be examples of a CTS-1305, a CF-End6 1310-a, and a CTS6 1315-a with reference to FIG. 13. FIG. 14 may also include STA1 access time S1A 1420-a which may correspond to interval 1320.

As shown in FIG. 14, a first sequence may include a CTS1 1405 followed by a CF-End6 1410, which may be followed by CTS6 1415, which may be followed by a S1A 1420. The sequence may then be repeated in a following sequence.

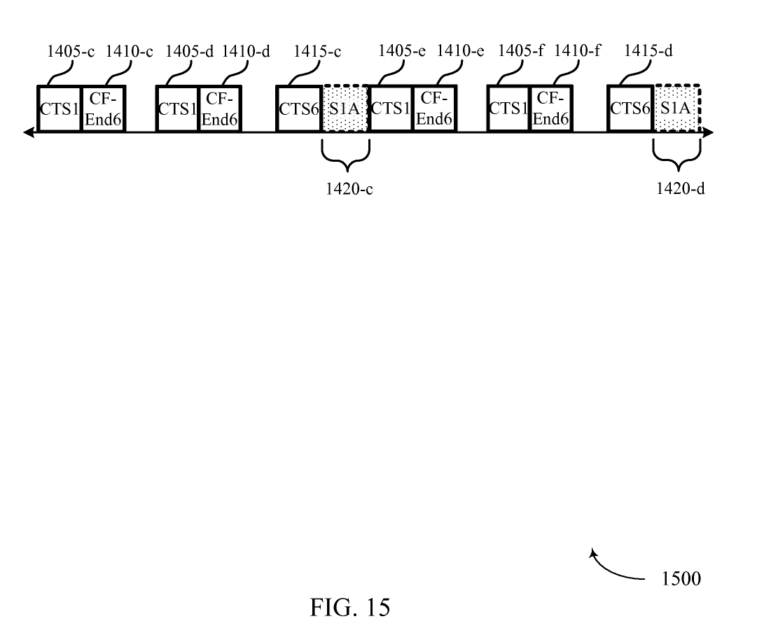

FIG. 15 is a timing diagram showing an example of STA1 access 1500 with intermediate NAV1 reinforcement. FIG. 15 may incorporate aspects of FIGS. 13-14. In the example of FIG. 15, a CTS1 1405-c, CF-End6 1410-c pair may be followed may be followed by another CTS1 1405-d, CF-End6 1410-d pair, which may be followed by a CTS6 1415-c, an S1A 1420-c. The sequence may then be repeated in a following sequence. Thus, the depicted time period may include intermediate NAV1 reinforcement (i.e., a second CTS1 1405-d, CF-End6 1410-d pair is transmitted prior to the next CTS6 1415-c).

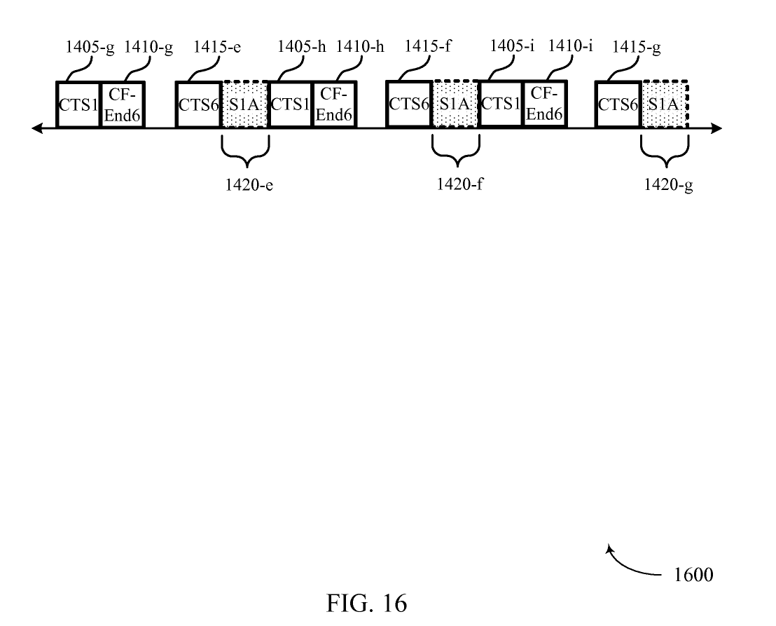

FIG. 16 is a timing diagram showing an example of STA1 access 1600 with a shorter interval. FIG. 16 may incorporate aspects of FIGS. 13-15. FIG. 16 may depict an example in which the interval between each sequence of transmissions is reduced. Thus, FIG. 16 shows one possible manner of variation in the examples described in with reference to FIGS. 13-14.

As an example, when the AP 105 detects activity during an S1A period, the AP 105 may temporarily reduce the interval between S1A periods, as depicted in FIG. 16. When the AP 105 detects activity during an S1A period, the AP 105 may temporarily reduce the NAV1 1330 time and increase the NAV6 1335 time, so that the active STA1 device(s) have more channel access time.

When the AP 105 detects activity during an S1A period, it may activate protection and disable the periodic switching between NAV1 1330 and NAV6 1335, so that channel access between STA1 and STA6 devices becomes fully fair according to the channel access procedures (according to the Enhanced Distributed Channel Access (EDCA) mechanism of contended access). In the absence of activity, the AP 105 may disable the switching between NAV1 1330 and NAV6 1335 periods, to reduce the number of transmitted frames.

In the presence of STA6 activity, the AP 105 may pro-actively enable switching between NAV1 1330 and NAV6 1335 periods, in order to make STA1 access more reliable (because there will be less collisions with hidden STA6 transmissions). The pro-active enabling may improve discovery of the AP 105 through Probe Requests transmitted by STA1 devices, and it may improve the process of association and authentication by STA1 devices with the AP 105.

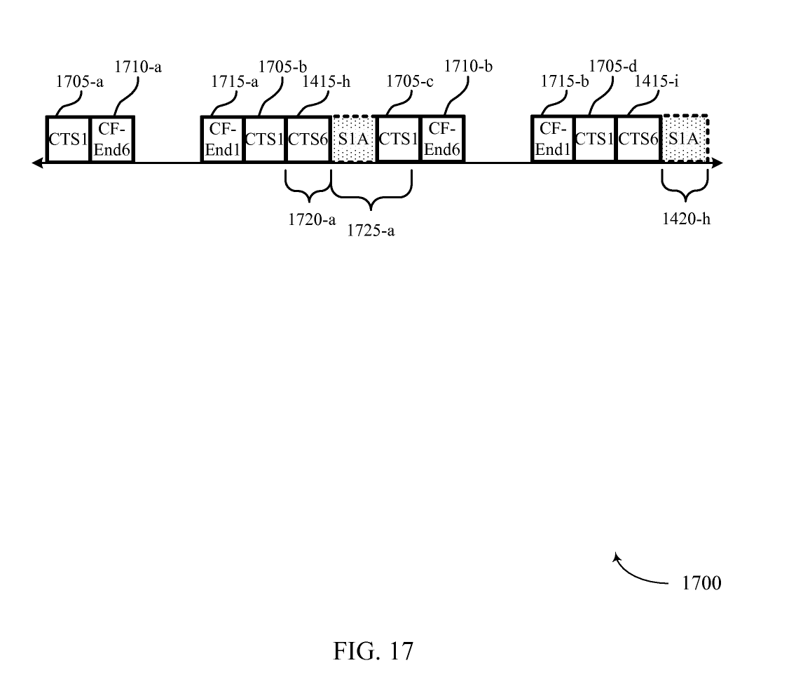

FIG. 17 is a timing diagram showing an example of STA access 1700. FIG. 17 may incorporate aspects of FIGS. 13-16. FIG. 17 may also include blocks CTS1 1705, which may be CTS transmissions by an AP 105 at 1 Mbps; blocks CTS6 1410, which may be CTS transmissions by the AP 105 at 6 Mbps; blocks CF-End6 1710, which may be CF-End transmissions by the AP 105 at 6 Mbps; and blocks CF-End1 1715, which may be a CF-End transmissions by the AP 105 at 1 Mbps.

CTS1 1705-a may set a NAV period for STA1 and STA6 devices, and CF-End6 1710-a may cancel the NAV period for just the STA6 devices, thereby establishing a protected period (“NAV1”) during which the STA6 devices may access the channel without interference by the STA1 devices and vice versa, a period during which STA1 devices are protected against accessing the channel while potentially invisible STA6 transmissions may be in progress. CF-End1 1715-a may then cancel the NAV1 period for the STA1 and STA6 devices. CTS1 1705-b may protect a CTS6 1415-h transmission during a protection interval 1720-a that covers just the time associated with transmitting the CTS6 1415-h transmission. The CTS6 1415-h transmission may be invisible to STA1 devices. The CTS6 1415-h transmission may be hidden from STA1 devices and establish a period (“NAV6”) during which STA1 devices may access the channel without interference by the STA6 devices. The NAV6 period 1725-a may include a remote station initial access period S1A. Thus, rather than waiting for NAV1 period to expire before the start of the S1A period, the NAV1 period may be actively truncated by transmitting a CF-End1 1715-a, followed by a CTS1 1705-b transmission, followed by a CTS6 1415-h transmission that establishes the NAV6 period, which includes the remote station initial access period S1A.

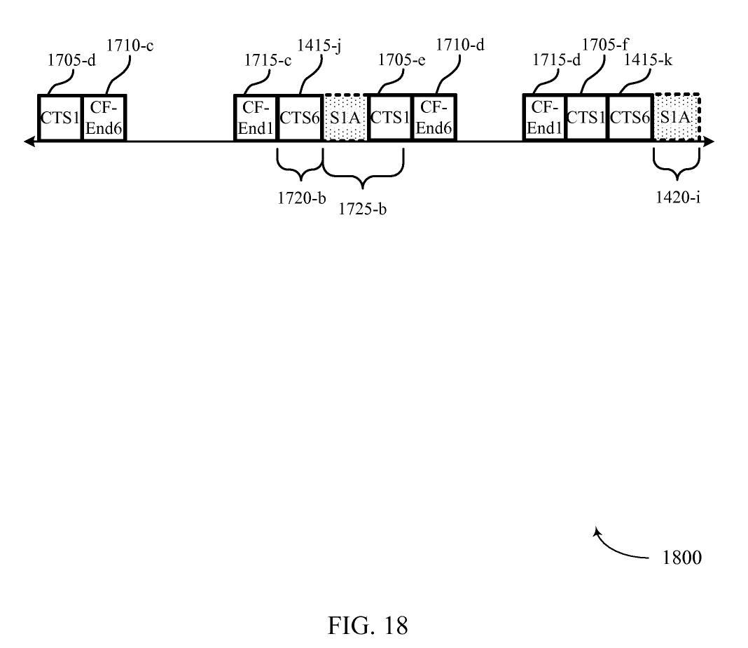

FIG. 18 is a timing diagram showing an example of STA access 1800. FIG. 18 may incorporate aspects of FIGS. 13-17. Specifically, FIG. 18 shows an adaptation of the STA access 1700 scheme from FIG. 17. Actively truncating a NAV1 may be useful in a situation where an overlapping BSS also deploys a similar protection mechanism, in which case different APs may continually set up a NAV1 period such that the NAV1 period never expires (or expires after a relatively long period). It may be possible to at least partially protect a CTS6 1415-j transmission using an Arbitration Interframe Space (AIFS) of the 51 devices, in which case the CTS1 protection (see CTS1 1705-b protection of the CTS6 1415-h, transmission, with reference to FIG. 17) may be removed. That is, in contrast to FIG. 17, CTS6 1415-j may follow CF-End1 1715-c without an intervening CTS1 1705. An AIFS may precede a backoff, which may precede a transmission. At 802.11b-only (STAT) devices, the AIFS (or DIFS) may be relatively long due to the use of long slots. When short slots are used, the AIFS may still provide some level of protection of the CTS6 1410-j transmission, which may be sufficient in some situations.

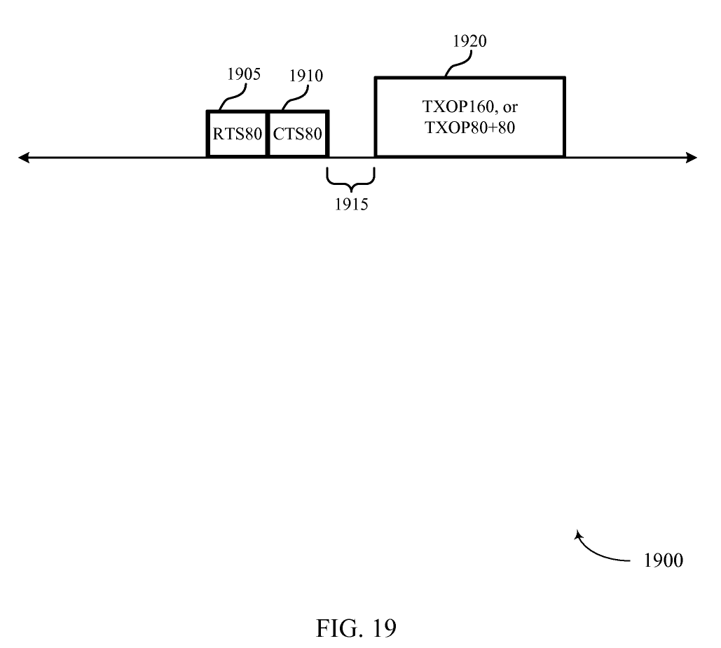

FIG. 19 is a timing diagram showing an example of wideband transmit opportunity 1900. FIG. 19 may depict an exemplary frame exchange sequence that enables announcement of a pending wideband TXOP through an RTS/CTS exchange with a smaller bandwidth (BW). The term wideband may refer to a bandwidth that is larger than the standard channel bandwidth. Thus, for WLANs using a standard 80 MHz channel bandwidth, a wideband bandwidth may refer to a transmission over an optional 160 MHz channel bandwidth or an optional 80+80 MHz channel bandwidth. Within this context, a STA may announce a pending wideband transmission by transmitting a Request to Send (RTS) frame over the standard 80 MHz channel bandwidth (an “RTS80 transmission 1905”) indicating a request for a wideband TXOP. The RTS80 transmission 1905 may indicate the request for the wideband transmit opportunity by requesting a NAV that covers just the time associated with a corresponding Clear to Send (CTS) transmission (a “CTS80 transmission 1910”) from the AP. For example, the RTS80 transmission may request a NAV period ending before or at the end of the corresponding CTS80 transmission 1910. The RTS80 transmission 1905 may request a NAV period equal to 0. After receiving the CTS80 transmission 1910, the STA may perform a secondary clear channel assessment (CCA) for the wideband bandwidth during a Point Coordination Function (PCF) Interframe Space (PIFS) interval 1915. In examples where the wideband transmission is over two 80 MHz channels, the secondary CCA may be performed on a secondary 80 MHz channel. Following a successful secondary CCA, a wideband TXOP 1920 may begin for the wideband transmission. The wideband transmission may be protected with a new wideband RTS/CTS exchange, which may include the transmitter of the CTS sensing the CCA in the secondary channels at least PIFS time prior to the RTS (hence the PIFS interval between the 80 MHz RTS/CTS and the 160 or 80+80 MHz TXOP). The transmitter of the 160 or 80+80 MHz TXOP may also sense the secondary channel CCA for at least a PIFS time prior to the wideband TXOP.

Announcing a wideband TXOP 1920 through a smaller band RTS/CTS exchange (e.g., RTS80 1905 and CTS80 1910) may allow a recipient STA to listen on the smaller bandwidth until the actual start of the wideband TXOP 1920. The PIFS 1915 interval may be extended to allow for settle time to activate receiving by a recipient of the wideband transmission on the wider bandwidth.

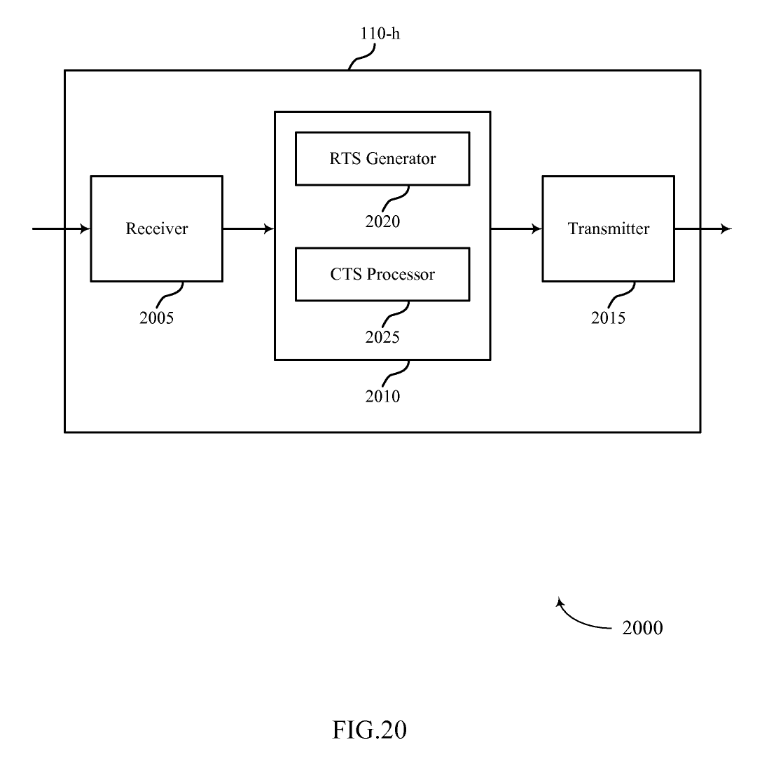

FIG. 20 shows a block diagram 2000 of a device (e.g., a station 110-h) for initiating a wideband transmit opportunity in accordance with various embodiments. The station 110-h may be an example of one or more aspects of a station 110 described above. The station 110-h may include a receiver 2005, a wideband TXOP initiator 2010, or a transmitter 2015. The station 110-h may also include or be implemented by a processor. Each of these components may be in communication with each other. The congestion wideband TXOP initiator 2010 may also include an RTS generator 2020 and a CTS processor 2025.

The components of the station 110-h may, individually or collectively, be implemented with at least one ASIC adapted to perform some or all of the applicable functions in hardware. Alternatively, the functions may be performed by one or more other processing units (or cores), on at least one IC. In other embodiments, other types of integrated circuits may be used (e.g., Structured/Platform ASICs, an FPGA, or another Semi-Custom IC), which may be programmed in any manner known in the art. The functions of each unit may also be implemented, in whole or in part, with instructions embodied in a memory, formatted to be executed by one or more general or application-specific processors.

The receiver 2005 may receive information which may be passed on to the wideband TXOP initiator 2010, and to other components of the station 110-h. The transmitter 2015 may transmit signals received from the wideband TXOP initiator 2010, and other components of the station 110-h.

The wideband TXOP initiator 2010 may include an RTS generator 2020 to generate a Request to Send (RTS) frame to be transmitted over a first bandwidth (e.g., a standard channel bandwidth, such as 80 MHz for 802.11ac devices). The RTS frame may indicate a request for a wideband transmit opportunity having a second bandwidth (e.g., an optional wideband bandwidth, such as 160 MHz for 802.11ac devices), the second bandwidth being larger than the first bandwidth as described above with reference to FIG. 19. The RTS frame may be transmitted over the first bandwidth by the transmitter 2015. The wideband TXOP initiator 2010 may also include a CTS processor 2025 to process a Clear to Send (CTS) frame received by the receiver 2005 over the first bandwidth as described above with reference to FIG. 19. The processing by the CTS processor 2025 may allow the station 110-h to determine that access to the second bandwidth has been granted to the station 110-h for the wideband transmission. Following receipt of the CTS frame, the wideband TXOP initiator 2010 may also be configured to coordinate a wideband transmission by the transmitter 2015 over the second bandwidth as described above with reference to FIG. 19. The data or signaling for the wideband transmission may be received from or generated in cooperation with other components of the station 110-h, which are not shown for clarity. The TXOP initiator 2010 or another component of the station 110-h may be configured to perform a clear channel assessment (CCA), such as a secondary CCA, on all or some of the second bandwidth prior to the wideband transmission.

The RTS generator 2020 may be configured to generate and transmit a Request to Send (RTS) frame over a first bandwidth as described above with reference to the wideband TXOP initiator 2010 and FIG. 19 (in coordination with the transmitter 2015).

The CTS processor 2025 may be configured to receive a Clear to Send (CTS) frame over the first bandwidth as described above with reference to wideband TXOP initiator 2010 and FIG. 19 (in coordination with receiver 2005).

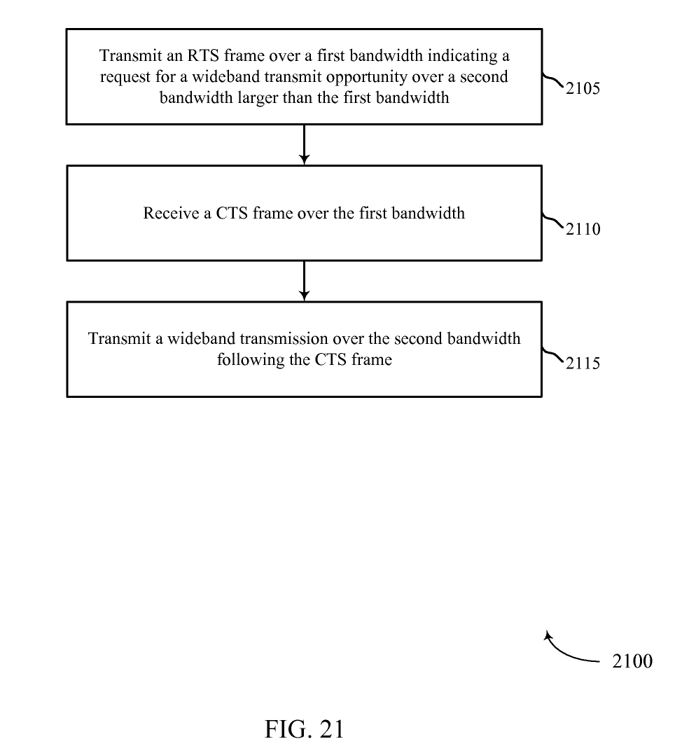

FIG. 21 shows a flowchart 2100 of a method for initiating a wideband transmit opportunity. The steps illustrated by flowchart 2100 may incorporate aspects of the methods described above with reference to FIG. 19. For clarity, the method 2000 is described below with reference to one or more aspects of a station 110, (in one example, a DSSS remote station 215) described with reference to previous Figures. A station 110 may execute one or more sets of codes to perform the functions described below.

At block 2105, a station 110 may transmit a Request to Send (RTS) frame over a first bandwidth, wherein the RTS frame indicates a request for a wideband transmit opportunity comprising a second bandwidth, wherein the second bandwidth is larger than the first bandwidth as described above with reference to FIG. 19. The functions of block 2105 may be performed by the RTS generator 2020 (in coordination with the transmitter 2015) with reference to FIG. 20.

At block 2110, a station 110 may receive a Clear to Send (CTS) frame over the first bandwidth as described above with reference to FIG. 19. The functions of block 2105 may be performed by the CTS processor 2025 (in coordination with the receiver 2005) with reference to FIG. 20.

At block 2115, a station 110 may transmit a wideband transmission over the second bandwidth following the CTS frame as described above with reference to FIG. 19. The functions of block 2105 may be performed by the transmitter 2015 with reference to FIG. 20. The time between the wideband transmission and the CTS frame may be at least PIFS.

Thus, the method 2100 may provide for initiating a wideband transmit opportunity using transmission on a narrower bandwidth. It should be noted that the method 2100 is just one implementation and that the operations of the method 2100 may be rearranged or otherwise modified such that other implementations are possible.

In yet other aspects of the above described methods, the method may include transmitting a Request to Send (RTS) frame over a first bandwidth, wherein the RTS frame indicates a request for a wideband transmit opportunity comprising a second bandwidth, wherein the second bandwidth is larger than the first bandwidth; receiving a Clear to Send (CTS) frame over the first bandwidth; and transmitting a wideband transmission over the second bandwidth following the CTS frame. A network allocation vector (NAV) of the RTS frame indicates the request for the wideband transmit opportunity. For example, the NAV period of the RTS frame is one of the group consisting of: a NAV period ending at an end of the CTS frame, a NAV period ending before the end of the CTS frame. A secondary clear channel assessment (CCA) may be performed for the wideband transmission during a Point Coordination Function (PCF) Interframe Space (PIFS) interval associated with the CTS frame. A length of the PIFS duration may be based at least in part on a settle time associated with activating wideband receiving at a receiving device.

A wireless communication device may include a transmitter to transmit a Request to Send (RTS) frame over a first bandwidth, wherein the RTS frame indicates a request for a wideband transmit opportunity comprising a second bandwidth, wherein the second bandwidth is larger than the first bandwidth; a receiver to receive a Clear to Send (CTS) frame over the first bandwidth; wherein the transmitter is further to transmit a wideband transmission over the second bandwidth following the CTS frame.

A wireless communications device may include means for transmitting a Request to Send (RTS) frame over a first bandwidth, wherein the RTS frame indicates a request for a wideband transmit opportunity comprising a second bandwidth, wherein the second bandwidth is larger than the first bandwidth; means for receiving a Clear to Send (CTS) frame over the first bandwidth; and means for transmitting a wideband transmission over the second bandwidth following the CTS frame.

A computer program product may include a non-transitory computer-readable medium storing instructions executable by a processor to: transmit a Request to Send (RTS) frame over a first bandwidth, wherein the RTS frame indicates a request for a wideband transmit opportunity comprising a second bandwidth, wherein the second bandwidth is larger than the first bandwidth; receive a Clear to Send (CTS) frame over the first bandwidth; and transmit a wideband transmission over the second bandwidth following the CTS frame.

Techniques described herein may be used for various wireless communications systems such as an IEEE 802.11 (Wi-Fi, Wi-Fi P2P, Wi-Fi Direct, etc.) system. The techniques described herein may be used for the systems and radio technologies mentioned above as well as other systems and radio technologies. The description above, however, describes a WLAN system for purposes of example, and WLAN terminology is used in much of the description above, although the techniques are applicable beyond WLAN applications.

The detailed description set forth above in connection with the appended drawings describes exemplary embodiments and does not represent the only embodiments that may be implemented or that are within the scope of the claims. The term “exemplary” used throughout this description means “serving as an example, instance, or illustration,” and not “preferred” or “advantageous over other embodiments.” The detailed description includes specific details for the purpose of providing an understanding of the described techniques. These techniques, however, may be practiced without these specific details. Well-known structures and devices are shown in block diagram form in order to avoid obscuring the concepts of the described embodiments.

Information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative blocks and components described in connection with the disclosure herein may be implemented or performed with a general-purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, multiple microprocessors, one or more microprocessors in conjunction with a DSP core, or any other such configuration.

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described above can be implemented using software executed by a processor, hardware, firmware, hardwiring, or combinations of any of these. Features implementing functions may also be physically located at various positions, including being distributed such that portions of functions are implemented at different physical locations. Also, as used herein, including in the claims, “or” as used in a list of items indicates a disjunctive list such that, for example, a list of “A, B, or C” means A or B or C or AB or AC or BC or ABC (i.e., A and B and C).

Computer-readable media includes both computer storage media and communication media including any medium that facilitates transfer of a computer program from one place to another. A storage medium may be any available medium that can be accessed by a general purpose or special purpose computer. By way of example, and not limitation, computer-readable media can comprise RAM, ROM, EEPROM, CD-ROM or other optical disk storage, magnetic disk storage or other magnetic storage devices, or any other medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include compact disc (CD), laser disc, optical disc, digital versatile disc (DVD), floppy disk and Blu-ray disc where disks usually reproduce data magnetically, while discs reproduce data optically with lasers. Combinations of the above are also included within the scope of computer-readable media.

The previous description of the disclosure is provided to enable a person skilled in the art to make or use the disclosure. Various modifications to the disclosure will be readily apparent to those skilled in the art, and the generic principles defined herein may be applied to other variations without departing from the scope of the disclosure. Throughout this disclosure the term “example” or “exemplary” indicates an example or instance and does not imply or require any preference for the noted example. Thus, the disclosure is not to be limited to the examples and designs described herein but is to be accorded the widest scope consistent with the principles and novel features disclosed herein.

What is claimed is:

1. A method of wireless communication comprising:
transmitting, from an access point, an orthogonal frequency division multiplexing (OFDM) signal indicating a Network Allocation Vector (NAV) period associated with a remote station initial access period; and
receiving a Direct Sequence Spread Spectrum (DSSS) transmission from a remote station during the remote station initial access period.

2. The method of claim 1, further comprising:
transmitting a DSSS signal that announces the OFDM signal prior to transmitting the OFDM signal.

3. The method of claim 1, wherein the OFDM signal comprises a Clear to Send (CTS) frame.

4. The method of claim 3, wherein the CTS frame is addressed to a node other than the remote station.

5. The method of claim 1, further comprising:
transmitting an instruction to use legacy protection within a wireless local area network (WLAN) of the access point based on the received DSSS transmission.

6. The method of claim 5, further comprising:
discontinuing periodic transmission of the OFDM signal in response to the use of legacy protection in the WLAN.

7. A method of wireless communication comprising:
receiving, at a wireless station, an indication of a Network Allocation Vector (NAV) period associated with remote station initial access;
monitoring for radio transmissions during the indicated NAV period; and
transmitting a DSSS signal during the indicated NAV period based on the monitoring.

8. The method of claim 7, further comprising:
determining that the indicated NAV period is associated with the remote station initial access based on an absence of detected radio transmissions to an access point during the indicated NAV period.

9. The method of claim 7, further comprising:
determining that the wireless station is a remote station based on an absence of detected radio transmissions to an access point during the indicated NAV period.

10. The method of claim 9, further comprising:
adjusting a backoff window of the wireless station based on the determination that the wireless station is a remote station.

11. The method of claim 9, wherein the transmission of the DSSS signal is based on the determination that the wireless station is a remote station.

12. The method of claim 7, further comprising:
receiving an instruction to use legacy protection within a wireless local area network (WLAN) of the access point in response to transmitting the DSSS signal.

13. A wireless communications device comprising:
a receiver to receive an indication of a Network Allocation Vector (NAV) period associated with remote station initial access;
an access manager to monitor for radio transmissions during the indicated NAV period; and
a Direct Sequence Spread Spectrum (DSSS) communications manager to transmit a DSSS signal during the indicated NAV period based on the monitoring.

14. The wireless communication device of claim 13, wherein the access manager is further to:
determine that the indicated NAV period is associated with the remote station initial access based on an absence of detected radio transmissions to an access point during the indicated NAV period.

15. The wireless communication device of claim 13, wherein the access manager is further to:
determine that the wireless station is a remote station based on an absence of detected radio transmissions to an access point during the indicated NAV period.

16. The wireless communication device of claim 15, wherein the access manager is further to:
adjust a backoff window of the wireless station based on the determination that the wireless station is a remote station.

17. The wireless communication device of claim 15, wherein the transmission of the DSSS signal is based on the determination that the wireless station is a remote station.

18. The wireless communication device of claim 13, wherein the receiver is further to:
receive an instruction to use legacy protection within a wireless local area network (WLAN) of the access point in response to transmitting the DSSS signal.

19. A computer program product comprising a non-transitory computer-readable medium storing instructions executable by a processor to cause at least one device to:
receive an indication of a Network Allocation Vector (NAV) period associated with remote station initial access;
monitor for radio transmissions during the indicated NAV period; and
transmit a Direct Sequence Spread Spectrum (DSSS) signal during the indicated NAV period based on the monitoring.

20. The computer program product of claim 19, wherein the instructions are further executable to cause the at least one device to:
determine that the indicated NAV period is associated with the remote station initial access based on an absence of detected radio transmissions to an access point during the indicated NAV period.

21. The computer program product of claim 19, wherein the instructions are further executable to cause the at least one device to:
determine that the wireless station is a remote station based on an absence of detected radio transmissions to an access point during the indicated NAV period.

22. The computer program product of claim 21, wherein the instructions are further executable to cause the at least one device to:
adjust a backoff window of the wireless station based on the determination that the wireless station is a remote station.

23. The computer program product of claim 21, wherein the transmission of the DSSS signal is based on the determination that the wireless station is a remote station.

24. The computer program product of claim 19, wherein the instructions are further executable to cause the at least one device to:
receive an instruction to use legacy protection within a wireless local area network (WLAN) of the access point in response to transmitting the DSSS signal.
